(19) United States
(12) Patent Application Publication
(10) Pub. No.: US 2025/0056150 A1
(43) Pub. Date: Feb. 13, 2025

(54) SIGNAL SYNCHRONIZATION CIRCUIT, SIGNAL PROCESSING DEVICE, SIGNAL SYNCHRONIZATION METHOD, AND NON-TRANSITORY RECORDING MEDIUM

(71) Applicant: TDK CORPORATION, Tokyo (JP)

(72) Inventors: Toshihiro FUJII, Tokyo (JP); Satoshi KINOSHITA, Tokyo (JP); Mutsumi NAKANO, Tokyo (JP)

(73) Assignee: TDK CORPORATION, Tokyo (JP)

(21) Appl. No.: 18/718,604

(22) PCT Filed: Dec. 16, 2021
(86) PCT No.: PCT/JP2021/046632

§ 371 Date: Jun. 11, 2024

(51) Int. Cl. H04R 1/22

(52) U.S. Cl. CPC H04R 1/222

(57) ABSTRACT

A signal synchronization circuit of the invention includes: a detector that detects a sound source, based on a second signal out of a first signal supplied from a first microphone and the second signal supplied from a second microphone; a setter that sets a processing period, based on a result of detecting by the detector; a first delayer that delays the first signal; a second delayer that delays the second signal; a filter that generates a third signal by performing filtering processing, based on the second signal delayed by the second delayer; and a controller that controls operations of the first delayer, the second delayer, and the filter in the processing period to cause a signal difference between the first signal delayed by the first delayer and the third signal to become small.

### TECHNICAL FIELD

The disclosure relates to a signal synchronization circuit, a signal processing device, and a signal synchronization method that each performs synchronization of a plurality of signals obtained by a plurality of microphones, and a non-transitory recording medium that holds software that makes it possible to synchronize a plurality of signals obtained by a plurality of microphones.

### BACKGROUND ART

Some signal processing devices perform processing based on a plurality of signals obtained by a plurality of microphones. In such signal processing devices, for example, the signals are synchronized, and predetermined processing is performed based on the signals thus synchronized. For example, Patent Literature 1 discloses a technique of synchronizing a plurality of signals using a cross-correlation function.

### CITATION LIST

### Patent Literature

Patent Literature 1: Japanese Unexamined Patent Application Publication No. 2010-212818

### SUMMARY

A signal synchronization circuit according to an example embodiment of the disclosure includes a detector, a setter, a first delayer, a second delayer, a filter, and a controller. The detector is configured to detect a sound source, based on a second signal out of a first signal supplied from a first microphone and the second signal supplied from a second microphone. The setter is configured to set a processing period, based on a result of detecting by the detector. The first delayer is configured to delay the first signal. The second delayer is configured to delay the second signal. The filter is configured to generate a third signal by performing filtering processing, based on the second signal delayed by the second delayer. The controller is configured to control operations of the first delayer, the second delayer, and the filter in the processing period to cause a signal difference between the first signal delayed by the first delayer and the third signal to become small.

A signal processing device according to an example embodiment of the disclosure includes a signal synchronization circuit and a processing circuit. The signal synchronization circuit is configured to generate two signals by performing signal synchronization processing, based on a first signal supplied from a first microphone and a second signal supplied from a second microphone. The two signals correspond to the first signal and the second signal and are synchronized with each other. The processing circuit is configured to perform signal processing, based on the two signals. The signal synchronization circuit includes a detector, a setter, a first delayer, a second delayer, a filter, and a controller. The detector is configured to detect a sound source, based on the second signal. The setter is configured to set a processing period, based on a result of detecting by the detector. The first delayer is configured to delay the first signal. The second delayer is configured to delay the second signal. The filter is configured to generate a third signal by performing filtering processing, based on the second signal delayed by the second delayer. The controller is configured to control operations of the first delayer, the second delayer, and the filter in the processing period to cause a signal difference between the first signal delayed by the first delayer and the third signal to become small.

A signal synchronization method according to an example embodiment of the disclosure includes: detecting a sound source, based on a second signal out of a first signal supplied from a first microphone and the second signal supplied from a second microphone; setting a processing period, based on a result of detecting the sound source; delaying the first signal with a first delayer; delaying the second signal with a second delayer; generating a third signal by performing filtering processing with a filter, based on the second signal delayed by the second delayer; and controlling operations of the first delayer, the second delayer, and the filter in the processing period to cause a signal difference between the first signal delayed by the first delayer and the third signal to become small.

A non-transitory computer readable recording medium according to an example embodiment of the disclosure contains software. The software is configured to cause a processor to detect a sound source, based on a second signal out of a first signal supplied from a first microphone and the second signal supplied from a second microphone, set a processing period, based on a result of detecting the sound source, delay the first signal with a first delayer, delay the second signal with a second delayer, generate a third signal by performing filtering processing with a filter, based on the second signal delayed by the second delayer, and control operations of the first delayer, the second delayer, and the filter in the processing period to cause a signal difference between the first signal delayed by the first delayer and the third signal to become small.

### BRIEF DESCRIPTION OF DRAWINGS

FIG. 1 is a block diagram illustrating a configuration example of a signal processing device according to one example embodiment of the disclosure.

FIG. 2A is an explanatory diagram illustrating an operation example of a signal synchronization circuit illustrated in FIG. 1.

FIG. 2B is an explanatory diagram illustrating another operation example of the signal synchronization circuit illustrated in FIG. 1.

FIG. 3 is a waveform chart illustrating operation examples of a sound source detector and a sound source selector illustrated in FIG. 1.

FIG. 4 is an explanatory diagram illustrating an example of a filter coefficient of an adaptive filter illustrated in FIG. 1.

FIG. 5 is a block diagram illustrating an operation example of the signal synchronization circuit illustrated in FIG. 1.

FIG. 6 is an explanatory diagram illustrating the operation example of the signal synchronization circuit illustrated in FIG. 1.

FIG. 7 is another explanatory diagram illustrating the operation example of the signal synchronization circuit illustrated in FIG. 1.

FIG. 8 is another block diagram illustrating an operation example of the signal synchronization circuit illustrated in FIG. 1.

FIG. 9A is a flowchart illustrating the operation example of the signal synchronization circuit illustrated in FIG. 1.

FIG. 9B is another flowchart illustrating the operation example of the signal synchronization circuit illustrated in FIG. 1.

FIG. 9C is another flowchart illustrating the operation example of the signal synchronization circuit illustrated in FIG. 1.

FIG. 10 is a flowchart illustrating an example of convergence confirmation processing illustrated in FIG. 9C.

FIG. 11A is an explanatory diagram illustrating another example of the filter coefficient of the adaptive filter illustrated in FIG. 1.

FIG. 11B is an explanatory diagram illustrating an example of processing in which a peak position of the filter coefficient is adjusted.

FIG. 12 is an explanatory diagram illustrating another operation example of the signal synchronization circuit illustrated in FIG. 1.

FIG. 13A is a flowchart illustrating the other operation example of the signal synchronization circuit illustrated in FIG. 1.

FIG. 13B is another flowchart illustrating the other operation example of the signal synchronization circuit illustrated in FIG. 1.

FIG. 13C is another flowchart illustrating the other operation example of the signal synchronization circuit illustrated in FIG. 1.

FIG. 14 is a flowchart illustrating an example of convergence confirmation processing illustrated in FIG. 13C.

FIG. 15A is an explanatory diagram illustrating another operation example of the signal synchronization circuit illustrated in FIG. 1.

FIG. 15B is another explanatory diagram illustrating the other operation example of the signal synchronization circuit illustrated in FIG. 1.

FIG. 16A is a flowchart illustrating the other operation example of the signal synchronization circuit illustrated in FIG. 1.

FIG. 16B is another flowchart illustrating the other operation example of the signal synchronization circuit illustrated in FIG. 1.

FIG. 16C is another flowchart illustrating the other operation example of the signal synchronization circuit illustrated in FIG. 1.

FIG. 17 is a flowchart illustrating an example of convergence confirmation processing illustrated in FIG. 16C.

FIG. 18A is a flowchart illustrating another operation example of a signal synchronization circuit according to a modification example.

FIG. 18B is another flowchart illustrating the other operation example of the signal synchronization circuit according to the modification example.

FIG. 18C is another flowchart illustrating the other operation example of the signal synchronization circuit according to the modification example.

FIG. 19 is a block diagram illustrating a configuration example of a signal processing device according to another modification example.

### DETAILED DESCRIPTION

Synchronization processing of a plurality of signals obtained by a plurality of microphones is desirably performed more accurately with a small calculation amount.

It is desirable to provide a signal synchronization circuit, a signal processing device, a signal synchronization method, and a non-transitory recording medium that each make it possible to perform, more accurately with a small calculation amount, synchronization of a plurality of signals obtained by a plurality of microphones.

In the following, a description will be given in detail of some example embodiments of the disclosure with reference to the drawings.

### Example Embodiment

### Configuration Example

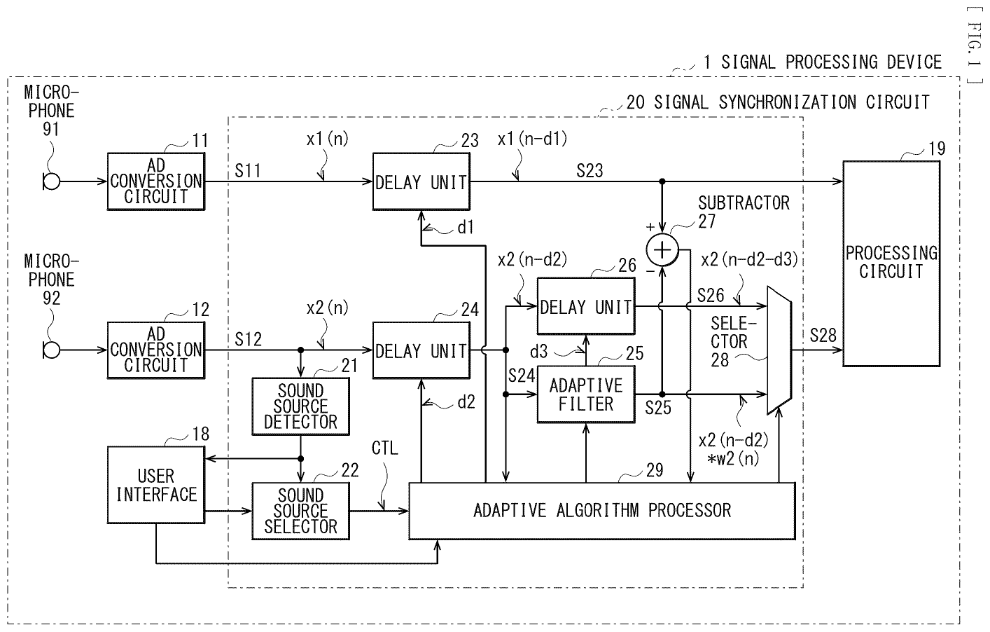

FIG. 1 illustrates a configuration example of a signal processing device 1 including a signal synchronization circuit according to an example embodiment of the disclosure. In this example, the signal processing device 1 is configured to synchronize two signals, based on the two signals supplied from two microphones, and perform predetermined signal processing, based on the two signals thus synchronized. The signal processing device 1 includes microphones 91 and 92, analog-to-digital (AD) conversion circuits 11 and 12, a user interface 18, a signal synchronization circuit 20, and a processing circuit 19.

Each of the microphones 91 and 92 is configured to convert a sound wave into an electric signal. The microphones 91 and 92 are arranged spaced apart from each other.

The AD conversion circuit 11 is configured generate a signal S11 by performing AD conversion, based on the electric signal supplied from the microphone 91. The AD conversion circuit 11 performs the AD conversion at a sampling frequency fs to thereby sequentially generate data x1, and outputs the data x1 as the signal S11. Data x1(n) illustrated in FIG. 1 represents nth data x1.

The AD conversion circuit 12 is configured to generate a signal S12 by performing AD conversion, based on the electric signal supplied from the microphone 92. The AD conversion circuit 12 performs the AD conversion at the sampling frequency fs to thereby sequentially generate data x2, and outputs the data x2 as the signal S12. Data x2(n) illustrated in FIG. 1 represents nth data x2. The AD conversion circuit 12 performs the AD conversion in synchronization with the AD conversion circuit 11.

The user interface 18 is configured to present information to a user of the signal processing device 1 and receive a user operation. The user interface 18 includes, for example, a display panel, an indicator, an operation button, and the like. The user is thus allowed to perform various settings of the signal processing device 1 by operating the user interface 18.

The signal synchronization circuit 20 is configured to generate two signals S23 and S28 by performing synchronization of the signal S11 and the signal S12. The two signals S23 and S28 respectively correspond to the signals S11 and S12 and synchronized with each other. The signal synchronization circuit 20 includes, for example, a processor, a memory, and the like, and is operated by executing software.

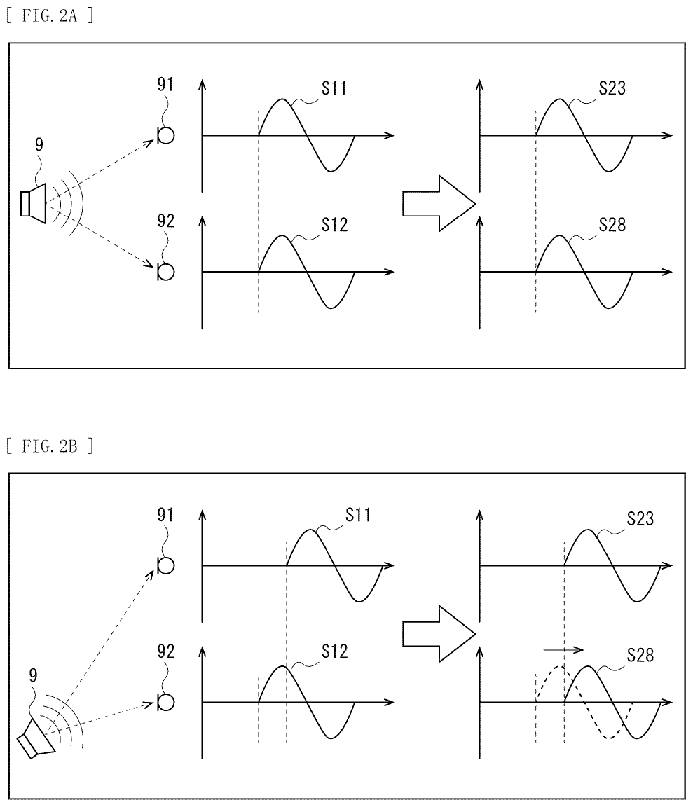

FIGS. 2A and 2B each schematically illustrate an operation of the signal synchronization circuit 20. FIG. 2A illustrates a case where a distance from a sound source 9 to the microphone 91 and a distance from the sound source 9 to the microphone 92 are substantially equal to each other, whereas FIG. 2B illustrates a case where the distance from the sound source 9 to the microphone 91 is longer than the distance from the sound source 9 to the microphone 92. Note that in FIGS. 2A and 2B, waveforms are depicted as sine waves for convenience of description.

For example, in the case where the distance from the sound source 9 to the microphone 91 and the distance from the sound source 9 to the microphone 92 are substantially equal to each other as illustrated in FIG. 2A, a sound wave emitted from the sound source 9 arrives at the two microphones 91 and 92 at substantially the same time; therefore, a phase of the signal S11 and a phase of the signal S12 are substantially equal to each other. Based on these two signals S11 and S12, the signal synchronization circuit 20 generates the two signals S23 and S28 synchronized with each other.

For example, in the case where the distance from the sound source 9 to the microphone 91 is longer than the distance from the sound source 9 to the microphone 92 as illustrated in FIG. 2B, a sound wave emitted from the sound source 9 arrives at the microphone 92 first, and thereafter arrives at the microphone 91; therefore, the phase of the signal S11 is delayed relative to the phase of the signal S12. In this case, the signal synchronization circuit 20 delays the phase of the signal S12, based on these two signals S11 and S12, to thereby generate the two signals S23 and S28 synchronized with each other.

The description has been given of the case where the distance from the sound source 9 to the microphone 91 is longer than the distance from the sound source 9 to the microphone 92 in the example of FIG. 2B; however, this applies similarly to a case where the distance from the sound source 9 to the microphone 91 is shorter than the distance from the sound source 9 to the microphone 92. In this case, the signal synchronization circuit 20 delays the phase of the signal S11, based on the two signals S11 and S12, to thereby generate the two signals S23 and S28 synchronized with each other.

Note that the description has been given, with reference to FIGS. 2A and 2B, of the example where a phase difference occurs between the signals S11 and S12, based on the difference in arrival time of the sound wave; however, this is non-limiting. A phase difference can occur between the signals S11 and S12 due to a difference in characteristic between the microphones 91 and 92, for example. Further, a phase difference can occur between the signals S11 and S12 due to a difference in characteristic between the AD conversion circuits 11 and 12, for example. Even in such cases, the signal synchronization circuit 20 is configured to generate the two signals S23 and S28 synchronized with each other, based on the two signals S11 and S12.

The signal synchronization circuit 20 illustrated in FIG. 1 includes a sound source detector 21, a sound source selector 22, delayers 23 and 24, an adaptive filter 25, a delayer 26, a subtractor 27, a selector 28, and an adaptive algorithm processor 29.

The sound source detector 21 is configured to detect the kind of a sound source, based on the signal S12.

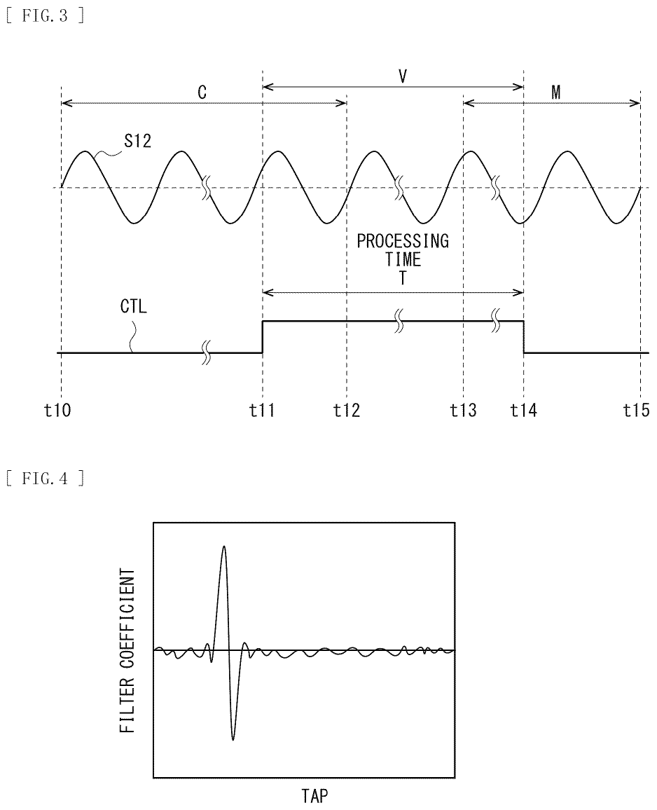

FIG. 3 illustrates operation examples of the sound source detector 21 and the sound source selector 22. The sound source detector 21 detects what sound source a signal component included in the signal S12 relates to, and generates meta-data indicating the kind of the sound source. In this example, “V” represents a human voice, “M” represents a musical sound, and “C” represents a vehicle traveling sound. The signal S12 includes a signal component of the vehicle traveling sound in a period from a timing t10 to a timing t12, a signal component of the human voice in a period from a timing t11 to a timing t14, and a signal component of the musical sound in a period from a timing t13 to a timing t15, for example.

Based on a signal component of a sound source whose S/N ratio is greater than or equal to a predetermined value among the signal components of various sound sources included in the signal S12, the sound source detector 21 detects the sound source indicated by the signal component. Specifically, in the example of FIG. 3, the sound source detector 21 generates meta-data indicating the vehicle traveling sound when the S/N ratio of the signal component of the vehicle traveling sound is greater than or equal to the predetermined value in the period from the timing t10 to the timing t12, generates meta-data indicating the human voice when the S/N ratio of the signal component of the human voice is greater than or equal to the predetermined value in the period from the timing t11 to the timing t14, and generates meta-data indicating the musical sound when the S/N ratio of the signal component of the musical sound is greater than or equal to the predetermined value in the period from the timing t13 to the timing t15. The sound source detector 21 supplies the metadata to the user interface 18 and the sound source selector 22.

Based on the meta-data supplied from the sound source detector 21, the user interface 18 illustrated in FIG. 1 presents information on the kind of the sound source to the user. The user recognizes, for example, that the signal processing device 1 has detected the human voice, the musical sound, the vehicle traveling sound, and the like. Thereafter, the user performs a selection operation to select a signal component of a sound source based on which the signal synchronization circuit 20 is to be operated out of these sound sources. The user interface 18 receives such a selection operation of the user. Thereafter, the user interface 18 supplies information on the selection operation of the user to the sound source selector 22.

The sound source selector 22 is configured to generate a control signal CTL, based on the meta-data supplied from the sound source detector 21 and the information on the selection operation of the user supplied from the user interface 18. The control signal CTL is a signal that is made active in a period including the signal component of the sound source selected by the user, and made inactive in other periods.

For example, when the user performs the selection operation to select the human voice in the example of FIG. 3, the sound source selector 22 makes the control signal CTL active (in this example, sets the control signal CTL to a high level) in the period from the timing t11 to the timing t14 including the signal component of the human voice, and makes the control signal CTL inactive (in this example, sets the control signal CTL to a low level) in the other periods. The sound source selector 22 generates the control signal CTL in this manner, and supplies the control signal CTL thus generated to the adaptive algorithm processor 29. The adaptive algorithm processor 29 performs adaptive algorithm processing, based on the control signal CTL in the period in which the control signal CTL is made active, i.e., a processing period T.

The delayer 23 illustrated in FIG. 1 is configured to generate the signal S23 by delaying the signal S11 by a delay amount d1. The delayer 23 delays the signal S11 by the delay amount d1 by shifting the phase of the signal S11 in units of a sampling period Ts(=1/fs). Data x1(n−d1) illustrated in FIG. 1 is data obtained by delaying the data x1(n) by the delay amount d1. The delay amount d1 of the delayer 23 is set by the adaptive algorithm processor 29.

The delayer 24 is configured to generate a signal S24 by delaying the signal S12 by a delay amount d2. The delayer 24 delays the signal S12 by the delay amount d2 by shifting the phase of the signal S12 in units of the sampling period Ts(=1/fs). Data x2(n−d2) illustrated in FIG. 1 is data obtained by delaying the data x2(n) by the delay amount d2. The delay amount d2 of the delayer 24 is set by the adaptive algorithm processor 29.

As described above, the delayer 23 delays the signal S11 by the delay amount d1, and the delayer 24 delays the signal S12 by the delay amount d2. In the signal synchronization circuit 20, the delay amount d1 of the delayer 23 and the delay amount d2 of the delayer 24 are individually set by the adaptive algorithm processor 29. Accordingly, even when either the phase of the signal S11 or the phase of the signal S12 advances relative to the other, the signal synchronization circuit 20 is allowed to perform synchronization by individually setting the delay amount d1 of the delayer 23 and the delay amount d2 of the delayer 24.

The adaptive filter 25 is configured to perform filtering processing, based on the signal S24 supplied from the delayer 24, to thereby generate a signal S25. The adaptive filter 25 is, for example, a finite impulse response (FIR) filter of about 100 taps. The adaptive filter 25 performs a convolution operation, based on the signal S24 and using a filter coefficient supplied from the adaptive algorithm processor 29. Data x2(n−d2)*w2(n) illustrated in FIG. 1 is data indicating a result of the convolution operation.

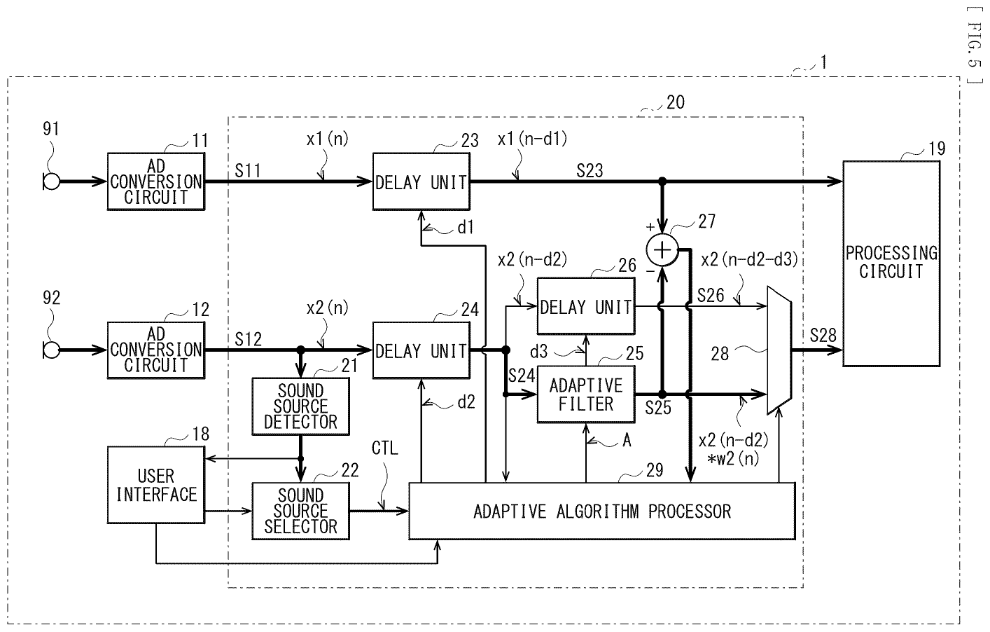

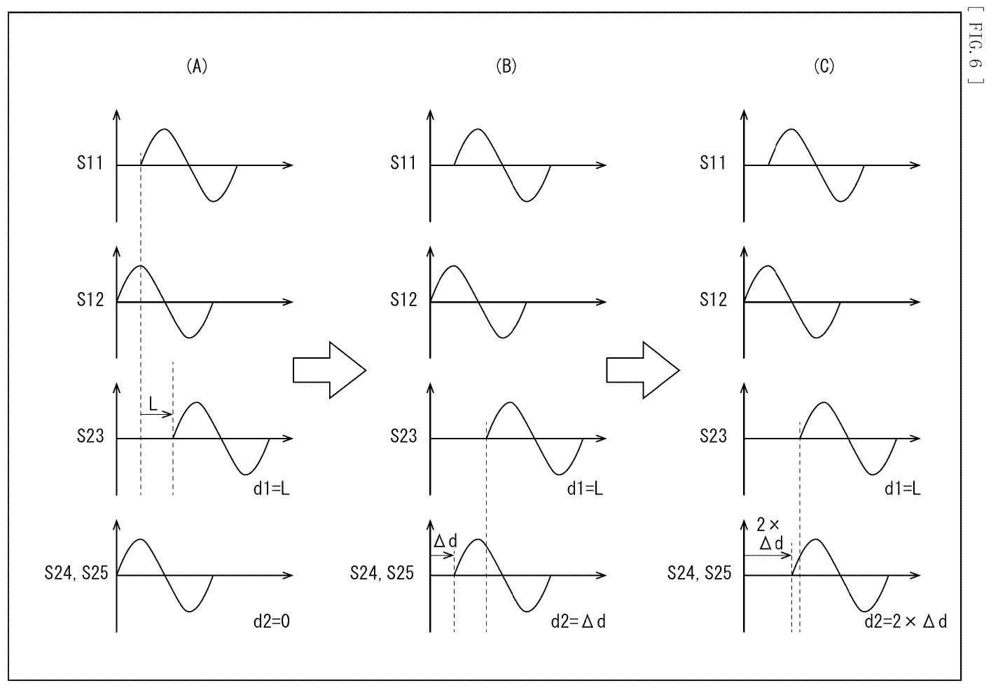

FIG. 4 illustrates an example of the filter coefficient of the adaptive filter 25. A horizontal axis represents taps of the adaptive filter 25. In FIG. 4, the leftmost tap has the lowest order, and the rightmost tap has the highest order. In other words, the leftmost tap corresponds to the smallest delay amount, and the rightmost tap corresponds to the largest delay amount. As illustrated in FIG. 4, a peak position that is a tap position at which an absolute value of the filter coefficient becomes maximum is desirably positioned on a left side of a half. This makes it possible to enhance convergence performance and synchronization accuracy of the signal synchronization circuit 20. In other words, because the filter coefficient includes primary coefficient data on a right side of the peak, it is possible to enhance the convergence performance and synchronization accuracy of the signal synchronization circuit 20 by narrowing a left range relative to the peak and widening a right range relative to the peak. For example, as illustrated in FIG. 4, the filter coefficient is so set that the peak occurs at a position of about 1/4 from the left.

The adaptive filter 25 is supplied, from the adaptive algorithm processor 29, with a filter coefficient A for both phase processing and amplitude processing, and a filter coefficient B only for phase processing. When the filter coefficient A for both the phase processing and the amplitude processing is supplied, the adaptive filter 25 performs the filtering processing in which both a phase and an amplitude of the signal S24 are processed. When the filter coefficient B only for the phase processing is supplied, the adaptive filter 25 performs the filtering processing in which only the phase of the signal S24 is processed.

The delayer 26 is configured to delay the signal S24 supplied from the delayer 24 by a delay amount d3 to thereby generate a signal S26. The delayer 26 delays the signal S24 by the delay amount d3 by shifting the phase of the signal S24 in units of the sampling period Ts(=1/fs). Data x2(n−d2−d3) illustrated in FIG. 1 is data obtained by delaying the data x2(n−d2) by the delay amount d3. The delay amount d3 of the delayer 26 is set to a value corresponding to the filter coefficient A of the adaptive filter 25 by the adaptive algorithm processor 29.

The subtractor 27 is configured to subtract the signal S25 supplied from the adaptive filter 25 from the signal S23 supplied from the delayer 23. Specifically, the subtractor 27 subtracts the data x2(n−d2)*w2(n) from the data x1(n−d1), for example.

The selector 28 is configured to select either the signal S26 supplied from the delayer 26 or the signal S25 supplied from the adaptive filter 25, based on an instruction from the adaptive algorithm processor 29, and to output the signal thus selected as the signal S28.

The adaptive algorithm processor 29 is configured control the operation of the signal synchronization circuit 20 by performing the adaptive algorithm processing in the period in which the control signal CTL supplied from the sound source selector 22 is made active, i.e., the processing period T. Specifically, the adaptive algorithm processor 29 controls operations of the delayers 23 and 24 and the adaptive filter 25 in the period in which the control signal CTL is made active so that a result of the subtraction at the subtractor 27 becomes small. In addition, the adaptive algorithm processor 29 maintains operation settings of the delayers 23 and 24 and the adaptive filter 25 in the period in which the control signal CTL is made inactive. Based on the signal S24 inputted to the adaptive filter 25 and the result of the subtraction at the subtractor 27, the adaptive algorithm processor 29 generates such a filter coefficient A of the adaptive filter 25 that the result of the subtraction at the subtractor 27 becomes small. In addition, the adaptive algorithm processor 29 converts the filter coefficient A into the filter coefficient B. Further, the adaptive algorithm processor 29 controls an operation of the selector 28.

The signal synchronization circuit 20 has two operation modes M1 and M2. In the operation mode M1, the adaptive algorithm processor 29 causes the adaptive filter 25 to operate until establishment of the synchronization, and after the establishment of the synchronization, sets the delay amount d3 of the delayer 26, based on the filter coefficient A of the adaptive filter 25, to thereby cause the delayer 26, instead of the adaptive filter 25, to operate. In the operation mode M2, the adaptive algorithm processor 29 causes the adaptive filter 25 to operate without causing the delayer 26 to operate before and after the establishment of the synchronization. The user selects either the operation mode M1 or the operation mode M2 by operating the user interface 18. Thereafter, the user interface 18 supplies the information on the selection operation of the user to the adaptive algorithm processor 29. This causes the adaptive algorithm processor 29 to control the operation of the signal synchronization circuit 20 in accordance with the selected operation mode out of the operation mode M1 and the operation mode M2.

In the operation mode M1, the adaptive algorithm processor 29 generates the filter coefficient A for both the phase processing and the amplitude processing, and supplies the filter coefficient A to the adaptive filter 25 until the establishment of the synchronization. After the establishment of the synchronization, the adaptive algorithm processor 29 sets the delay amount d3 of the delayer 26, based on the latest filter coefficient A, and stops generating the filter coefficient A from here forward.

In the operation mode M2, the adaptive algorithm processor 29 performs either first processing or second processing.

In the first processing, the adaptive algorithm processor 29 generates the filter coefficient A for both the phase processing and the amplitude processing and supplies the filter coefficient A to the adaptive filter 25 until the establishment of the synchronization. After the establishment of the synchronization, the adaptive algorithm processor 29 generates the filter coefficient A for both the phase processing and the amplitude processing and supplies the filter coefficient A to the adaptive filter 25.

In the second processing, the adaptive algorithm processor 29 generates the filter coefficient A for both the phase processing and the amplitude processing and supplies the filter coefficient A to the adaptive filter 25 until the establishment of the synchronization. After the establishment of the synchronization, the adaptive algorithm processor 29 generates the filter coefficient A for both the phase processing and the amplitude processing, converts the filter coefficient A into the filter coefficient B only for the phase processing, and supplies the filter coefficients A and B to the adaptive filter 25.

The user selects either the first processing or the second processing by operating the user interface 18. Thereafter, the user interface 18 supplies the information on the selection operation of the user to the adaptive algorithm processor 29. This causes the adaptive algorithm processor 29 to perform selected processing out of the first processing and the second processing.

With this configuration, the signal synchronization circuit 20 performs the synchronization of the signal S11 and the signal S12, to thereby generate the signals S23 and S28 that are respectively correspond to the signals S11 and S12 and synchronized with each other. Thereafter, the signal synchronization circuit 20 supplies the signals S23 and S28 to the processing circuit 19.

The processing circuit 19 is configured to perform predetermined signal processing, based on the signals S23 and S28. The predetermined signal processing is what is called microphone array signal processing, and includes, for example, processing to reduce noise and processing to focus on a target sound source.

Here, the sound source detector 21 corresponds to a specific example of a “detector” in one embodiment of the disclosure. The sound source selector 22 corresponds to a specific example of a “setter” in one embodiment of the disclosure. The delayer 23 corresponds to a specific example of a “first delayer” in one embodiment of the disclosure. The delayer 24 corresponds to a specific example of a “second delayer” in one embodiment of the disclosure. The adaptive filter 25 corresponds to a specific example of a “filter” in one embodiment of the disclosure. The delayer 26 corresponds to a specific example of a “third delayer” in one embodiment of the disclosure. The adaptive algorithm processor 29 corresponds to a specific example of a “controller” in one embodiment of the disclosure. The processing period T corresponds to a specific example of a “processing period” in one embodiment of the disclosure. The operation mode M1 corresponds to a specific example of a “first operation mode” in one embodiment of the disclosure. The operation mode M2 corresponds to a specific example of a “second operation mode” in one embodiment of the disclosure. The user interface 18 corresponds to a specific example of a “user interface” in one embodiment of the disclosure. The processing circuit 19 corresponds to a specific example of a “post-stage circuit” in one embodiment of the disclosure.

### [Operation and Workings]

Next, a description will be given of operation and workings of the signal processing device 1 of the present example embodiment.

### (Outline of Overall Operation)

First, an outline of overall operation of the signal processing device 1 will be described with reference to FIG. 1. Each of the microphones 91 and 92 converts a sound wave into an electric signal. The AD conversion circuit 11 generates the signal S11 by performing the AD conversion, based on the electric signal supplied from the microphone 91. The AD conversion circuit 12 generates the signal S12 by performing the AD conversion, based on the electric signal supplied from the microphone 92. The user interface 18 presents information to the user of the signal processing device 1 and receives a user operation. The signal synchronization circuit 20 generates the signals S23 and S28 by performing the synchronization of the signals S11 and S12. The signals S23 and S28 are respectively correspond to the signals S11 and S12 and synchronized with each other.

The sound source detector 21 of the signal synchronization circuit 20 detects the kind of the sound source, based on the signal S12, and generates the meta-data indicating the kind of the sound source. Based on the meta-data supplied from the sound source detector 21 and the information on the selection operation of the user supplied from the user interface 18, the sound source selector 22 generates the control signal CTL that is to be made active in the period including the signal component of the sound source selected by the user and to be made inactive in the other periods. The delayer 23 generates the signal S23 by delaying the signal S11 by the delay amount d1. The delayer 24 generates the signal S24 by delaying the signal S12 by the delay amount d2. The adaptive filter 25 generates the signal S25 by performing the filtering processing, based on the signal S24 supplied from the delayer 24. The delayer 26 generates the signal S26 by delaying the signal S24 supplied from the delayer 24 by the delay amount d3. The subtractor 27 subtracts the signal S25 from the signal S23. The selector 28 selects either the signal S26 supplied from the delayer 26 or the signal S25 supplied from the adaptive filter 25, based on the instruction from the adaptive algorithm processor 29, and outputs the selected signal as the signal S28. In the period in which the control signal CTL is made active, i.e., the processing period T, the adaptive algorithm processor 29 controls the operation of the signal synchronization circuit 20 by performing the adaptive algorithm processing.

The processing circuit 19 performs the predetermined signal processing, based on the signals S23 and S28 generated by the signal synchronization circuit 20.

### (Detailed Operation)

Next, a description will be given in detail of the operation of the signal synchronization circuit 20. The signal synchronization circuit 20 has the two operation modes M1 and M2. In the following, a description will be given in detail of an operation of the signal synchronization circuit 20 in each of the operation modes.

### (Operation Mode M1)

In the operation mode M1, the adaptive algorithm processor 29 causes the adaptive filter 25 to operate until the establishment of the synchronization, and after the establishment of the synchronization, sets the delay amount d3 of the delayer 26, based on the filter coefficient A of the adaptive filter 25, to thereby cause the delayer 26, instead of the adaptive filter 25, to operate. This operation is described in detail below.

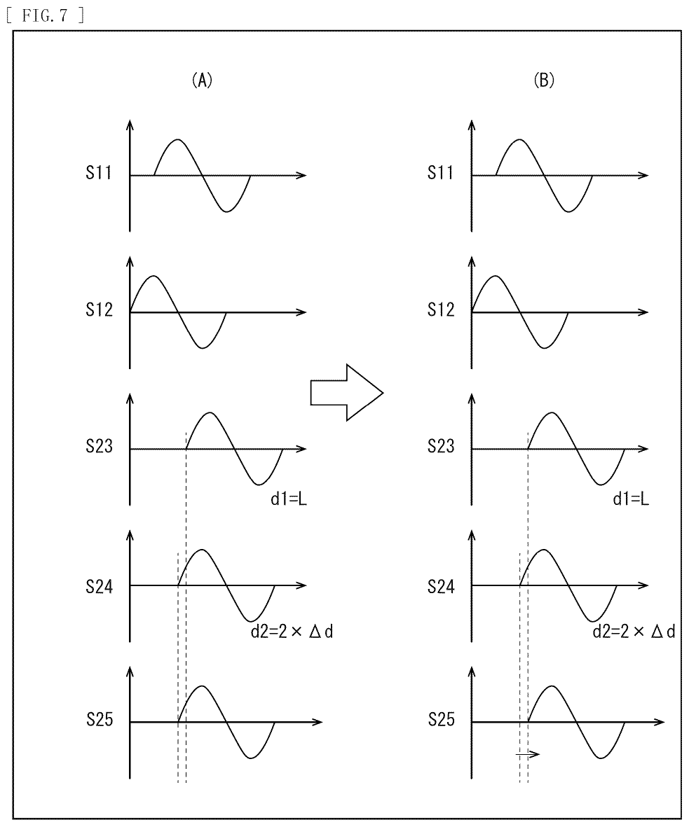

FIG. 5 illustrates an operation example of the signal synchronization circuit 20 at the time before the establishment of the synchronization. Paths indicated by thick lines indicate primary signal paths at the time before the establishment of the synchronization.

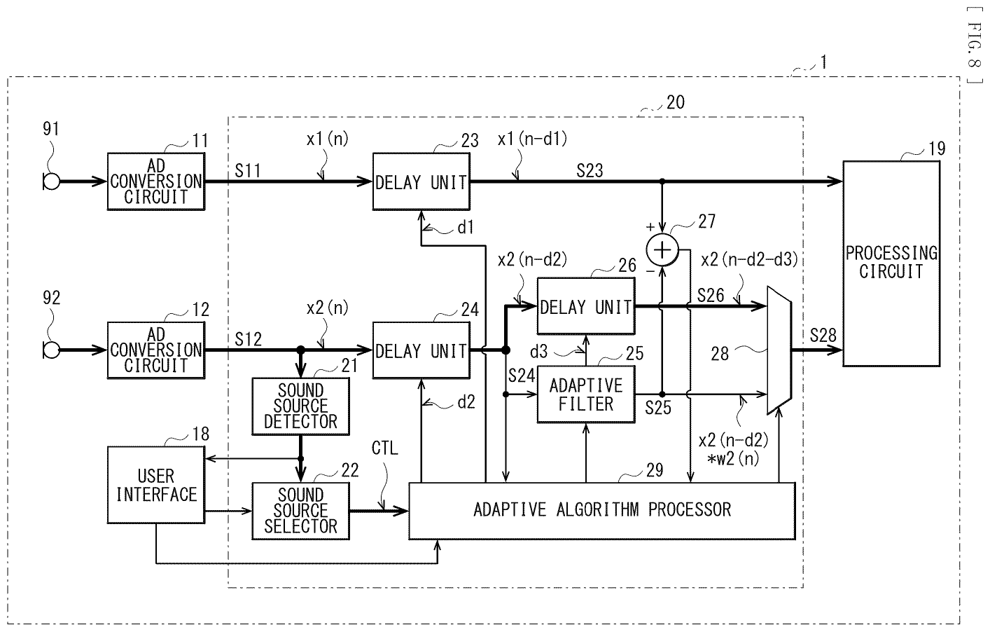

FIGS. 6 and 7 illustrate examples of the signals of the signal synchronization circuit 20 at the time before the establishment of the synchronization. In FIG. 6, the signals S24 are S25 are depicted as the same waveform for convenience of description; however, in practice, a phase of the signal S25 may be slightly delayed relative to the phase of the signal S24.

The delayer 23 illustrated in FIG. 5 generates the signal S23 by delaying the signal S11 by the delay amount d1. The delayer 24 generates the signal S24 by delaying the signal S12 by the delay amount d2. As illustrated in Part (A) of FIG. 6, the delay amount d1 of the delayer 23 is set to a predetermined amount L in an initial state. The predetermined amount L is a time corresponding to the number of taps of the adaptive filter 25. Specifically, when the number of taps is 100, for example, the predetermined amount L is a time corresponding to 100 sampling periods Ts. This allows the signal synchronization circuit 20 to operate in a stable manner when the adaptive filter 25 operates thereafter. That is, when the adaptive filter 25 operates, the phase of the signal S25 can be delayed; therefore, the delayer 23 delays the signal S11 by the predetermined amount L corresponding to a maximum value of an amount of phase adjustment by the adaptive filter 25, to thereby allow the signal synchronization circuit 20 to establish the synchronization thereafter.

The adaptive filter 25 illustrated in FIG. 5 thereafter generates the signal S25 by performing the filtering processing, based on the signal S24 supplied from the delayer 24. The subtractor 27 subtracts the signal S25 from the signal S23. The selector 28 outputs the signal S25 supplied from the adaptive filter 25 as the signal S28.

The adaptive algorithm processor 29 controls the operation of the signal synchronization circuit 20 by performing the adaptive algorithm processing in the period in which the control signal CTL is made active, i.e., the processing period T. Specifically, the adaptive algorithm processor 29 generates such a filter coefficient A of the adaptive filter 25 that the result of the subtraction at the subtractor 27 becomes small, based on the signal S24 inputted to the adaptive filter 25 and the result of the subtraction at the subtractor 27, in each of the periods corresponding to the sampling period Ts(=1/fs). The adaptive algorithm processor 29 monitors a convergence state, based on the result of the subtraction at the subtractor 27, for example. The adaptive algorithm processor 29 generates a convergence parameter C every time a standby time M, which is, for example, one second, elapses, and shifts the delay amount d1 of the delayer 23 or the delay amount d2 of the delayer 24 by a predetermined amount Δd when the convergence parameter C takes a value indicating that the convergence has not been completed yet. The convergence parameter C is a parameter indicating a degree of convergence, and, in this example, a parameter that increases in value as the convergence progresses. The adaptive algorithm processor 29 searches for such delay amounts d1 and d2 that the convergence parameter C takes a maximum value. Specifically, when the phase of the signal S23 is delayed relative to the phase of the signal S25 as illustrated in Part (A) of FIG. 6, for example, the adaptive algorithm processor 29 increases the delay amount d2 of the delayer 24 by the predetermined amount Δd as illustrated in Part (B) of FIG. 6, to thereby adjust a phase difference between the signals S23 and S25 to become small. For example, the predetermined amount Δd may be substantially equal to the predetermined amount L. However, this is non-limiting, and the predetermined amount Δd may be larger or smaller than the predetermined amount L, for example. As illustrated in Part (C) of FIG. 6, the adaptive algorithm processor 29 shifts the delay amount d1 of the delayer 23 or the delay amount d2 of the delayer 24 by the predetermined amount Δd until the phase difference between the signals S23 and S25 becomes small. Thereafter, as illustrated in Parts (A) and (B) of FIG. 7, the adaptive algorithm processor 29 generates such a filter coefficient A of the adaptive filter 25 that the phase difference between the signals S23 and S25 becomes smaller. Since the filter coefficient A is the filter coefficient for both the phase processing and the amplitude processing, the adaptive algorithm processor 29 adjusts the filter coefficient A so that a waveform of the signal S23 and a waveform of the signal S25 become equal to each other. Accordingly, the signal synchronization circuit 20 performs the adjustment mainly of the delay amount d1 of the delayer 23 and the delay amount d2 of the delayer 24, i.e., coarse adjustment as illustrated in FIG. 6 first, and thereafter performs the adjustment of the filter coefficient A of the adaptive filter 25, i.e., fine adjustment as illustrated in FIG. 7. Thereafter, the adaptive algorithm processor 29 determines that the synchronization has been established when the convergence parameter C takes a value indicating that the convergence has been completed.

FIG. 8 illustrates an operation example of the signal synchronization circuit 20 at the time after the establishment of the synchronization. Paths indicated by thick lines indicate primary signal paths at the time after the establishment of the synchronization.

Upon the establishment of the synchronization, the adaptive algorithm processor 29 sets the delay amount d3 of the delayer 26, based on the filter coefficient A generated last before the establishment of the synchronization. Thereafter, the adaptive algorithm processor 29 stops updating the filter coefficient A. The selector 28 outputs the signal S26 supplied from the delayer 26 as the signal S28.

In the following, a description will be given in detail of the operation of the signal synchronization circuit 20 with reference to a flowchart.

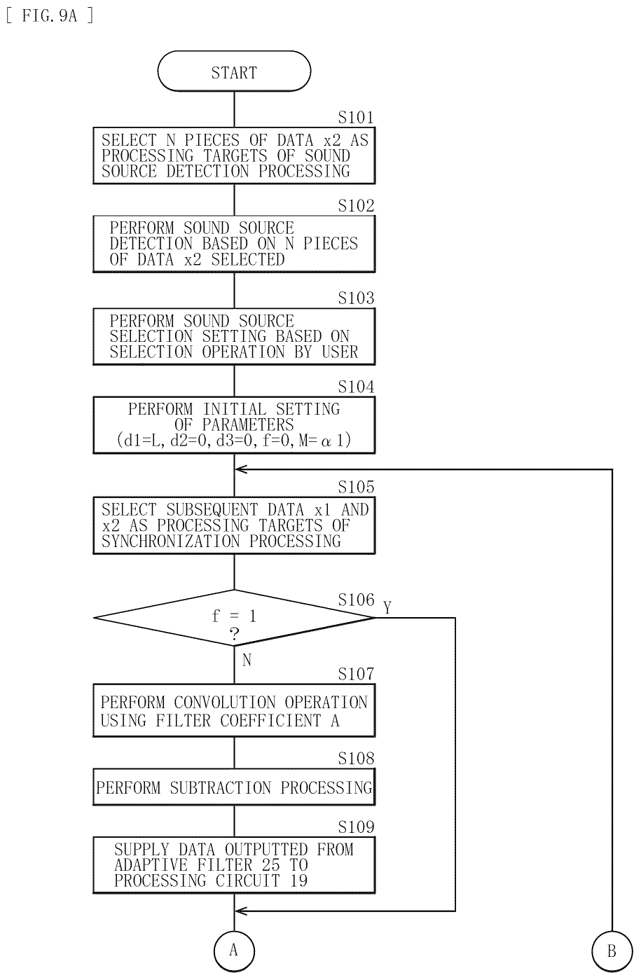

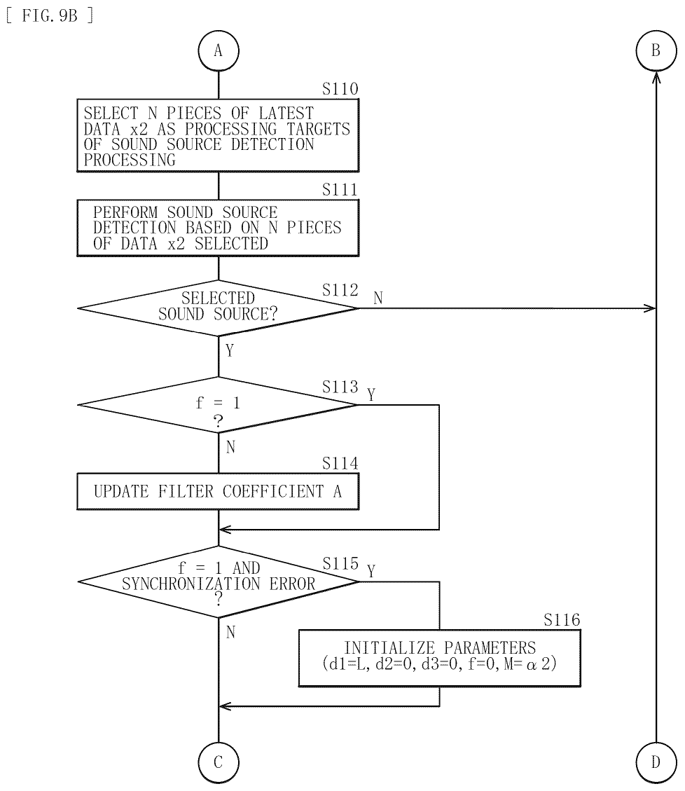

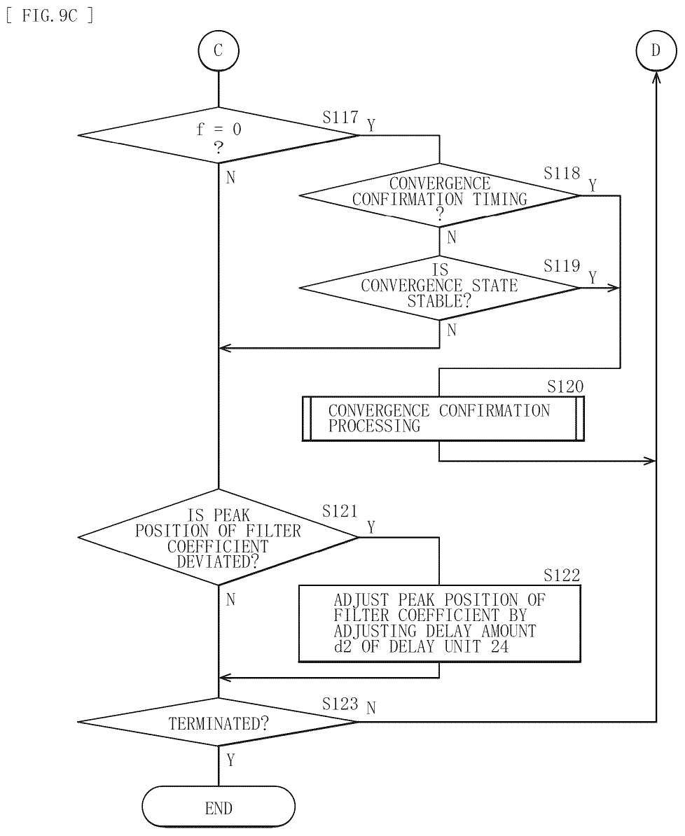

FIGS. 9A to 9C illustrate an operation example of the signal synchronization circuit 20 in the operation mode M1. In the signal processing device 1, the AD conversion circuit 11 performs sampling at the sampling frequency fs, based on the electric signal supplied from the microphone 91, to thereby sequentially generate a series of data x1. Likewise, the AD conversion circuit 12 performs sampling at the sampling frequency fs, based on the electric signal supplied from the microphone 92, to thereby generate a series of data x2. The signal synchronization circuit 20 performs processing, based on the series of data x1 and the series of data x2.

First, the adaptive algorithm processor 29 selects N pieces of the data x2 having been sequentially supplied, as processing targets of sound source detection processing (Step S101). Here, the N pieces of data x2 are, for example, data x2 for one second.

Thereafter, the sound source detector 21 performs the sound source detection, based on the N pieces of data x2 thus selected (Step S102). The sound source detector 21 detects what sound source the signal components included in the N pieces of data x2 relate to, and generates the meta-data indicating the kind of the sound source. Based on the meta-data supplied from the sound source detector 21, the user interface 18 presents the information on the kind of the sound source to the user. The user performs, with the user interface 18, the selection operation to select the signal component of the sound source based on which the signal synchronization circuit 20 is to be operated out of these sound sources.

Next, the user interface 18 performs sound source selection setting, based on the selection operation of the user (Step S103). Specifically, based on the selection operation of the user, the user interface 18 sets sound source data based on which the signal synchronization circuit 20 is to be operated.

Next, the adaptive algorithm processor 29 performs initial settings of parameters (Step S104). Specifically, the adaptive algorithm processor 29 sets the delay amount d1 of the delayer 23, the delay amount d2 of the delayer 24, and the delay amount d3 of the delayer 26 to “0”, sets a synchronization flag f to “0”, and sets the standby time M to “al”. The synchronization flag f is set to “0” before the establishment of the synchronization, and is set to “1” upon the establishment of the synchronization. The time α1 is, for example, one second.

Next, the adaptive algorithm processor 29 selects subsequent data x1 and x2 as processing targets of synchronization processing (Step S105).

Next, the adaptive algorithm processor 29 determines whether the synchronization flag f is “1” (f=1) (Step S106). When the synchronization flag f is determined to be “1” (“Y” in Step S106), the procedure proceeds to Step S110.

When the synchronization flag f is determined to be “0” in Step S106 (“N” in Step S106), the adaptive filter 25 performs the convolution operation using the filter coefficient A generated by the adaptive algorithm processor 29 (Step S107). For example, the adaptive algorithm processor 29 supplies the filter coefficient A having a predetermined value to the adaptive filter 25 first, and thereafter, the adaptive algorithm processor 29 supplies the filter coefficient A generated most recently to the adaptive filter 25. Based on the filter coefficient A supplied from the adaptive algorithm processor 29, the adaptive filter 25 performs the convolution operation.

Next, the subtractor 27 performs subtraction processing (Step S108). Specifically, the subtractor 27 subtracts the data x2(n−d2)*w2(n) outputted from the adaptive filter 25 from the data x1(n−d1) outputted from the delayer 23.

Next, the selector 28 supplies the data x2(n−d2)*w2(n) outputted from the adaptive filter 25 to the processing circuit 19 (Step S109).

Next, the adaptive algorithm processor 29 selects N pieces of the latest data x2 including the data x2 selected in Step S105 as processing targets of the sound source detection processing (Step S110).

Next, the sound source detector 21 performs the sound source detection, based on the N pieces of data x2 thus selected (Step S111). The sound source detector 21 detects the sound source that the signal components in the N pieces of data x2 included in the signal S12 relate to, and generates the meta-data indicating the kind of the sound source.

Next, the sound source selector 22 determines whether the sound source detected in Step S111 is the sound source selected in Step S103 (Step S112). When the detected sound source is determined not to be the selected sound source (“N” in Step S112), the procedure returns to Step S105.

When the detected sound source is determined to be the selected sound source in Step S112 (“Y” in Step S112), the adaptive algorithm processor 29 determines whether the synchronization flag f is “1” (f=1) (Step S113). When the synchronization flag f is determined to be “1” (“Y” in Step S113), the procedure proceeds to Step S115.

When the synchronization flag f is determined to be “0” in Step S113 (“N” in Step S113), the adaptive algorithm processor 29 updates the filter coefficient A (Step S114). Specifically, the adaptive algorithm processor 29 updates the filter coefficient A of the adaptive filter 25, based on the signal S24 inputted to the adaptive filter 25 and the result of the subtraction at the subtractor 27 so that the result of the subtraction at the subtractor 27 becomes small.

Next, the adaptive algorithm processor 29 determines whether the synchronization flag f is “1” (f=1) and whether a synchronization error has occurred (Step S115). That is, the synchronization error can occur in the signal synchronization circuit 20 even when the synchronization flag f is “1”. For example, the adaptive algorithm processor 29 may determine that the synchronization error has occurred when, for example, the processing circuit 19 expected to be supplied with the synchronized signals S23 and S28 is not capable of exhibiting sufficient performance. Further, the adaptive algorithm processor 29 may determine that the synchronization error has occurred when, for example, updating of the filter coefficient A in Step S114 has not been performed for a long time because a state in which the sound source detected in Step S111 is not determined to be the sound source selected in Step S103 has been retained for a long time after the establishment of the synchronization and the setting of the synchronization flag to “1”. Further, the adaptive algorithm processor 29 may determine that the synchronization error has occurred when, for example, the convergence has not been completed whatever values the delay amount d1 of the delayer 23 and the delay amount d2 of the delayer 24 are set to. The adaptive algorithm processor 29 determines whether the synchronization error has occurred when the synchronization flag f is determined to be “1” (f=1). When these conditions are determined not to be satisfied in the Step S115 (“N” in Step S115), the procedure proceeds to Step S117.

When the synchronization flag f is determined to be “1” (f=1) and the synchronization error is determined to have occurred in Step S115 (“Y” in Step S115), the adaptive algorithm processor 29 initializes the parameters (Step S116). Specifically, the adaptive algorithm processor 29 sets the delay amount d1 of the delayer 23, the delay amount d2 of the delayer 24, and the delay amount d3 of the delayer 26 to “0”, sets the synchronization flag f to “0”, and sets the standby time M to “α2”. The time α2 is longer than the time α1.

Next, the adaptive algorithm processor 29 determines whether the synchronization flag f is “0” (f=0) (Step S117). When the synchronization flag f is determined to be “1” (“N” in Step S117), the procedure proceeds to Step S121.

When the synchronization flag f is determined to be “0” in Step S117 (“Y” in Step S117), the adaptive algorithm processor 29 determines whether a convergence confirmation timing has come (Step S118). Specifically, the adaptive algorithm processor 29 determines that the convergence confirmation timing has come when, for example, a time indicated by the standby time M has elapsed since the start of the processing, or when the time indicated by the standby time M has elapsed since the previous convergence confirmation processing. When the convergence confirmation timing is determined to have come (“Y” in Step S118), the procedure proceeds to Step S120.

When the convergence confirmation timing is determined not to have come in Step S118 (“N” in Step S118), the adaptive algorithm processor 29 determines whether the convergence state is stable (Step S119). Specifically, the adaptive algorithm processor 29 may determine whether the convergence state is stable based on, for example, the result of the subtraction at the subtractor 27. When the convergence state is determined to be stable (“Y” in Step S119), the procedure proceeds to Step S120. When the convergence state is determined not to be stable (“N” in Step S119), the procedure proceeds to Step S121.

When the convergence confirmation timing is determined to have come in Step S118 (“Y” in Step S118) or when the convergence state is determined to be stable in Step S119 (“Y” in Step S119), the adaptive algorithm processor 29 performs the convergence confirmation processing (Step S120).

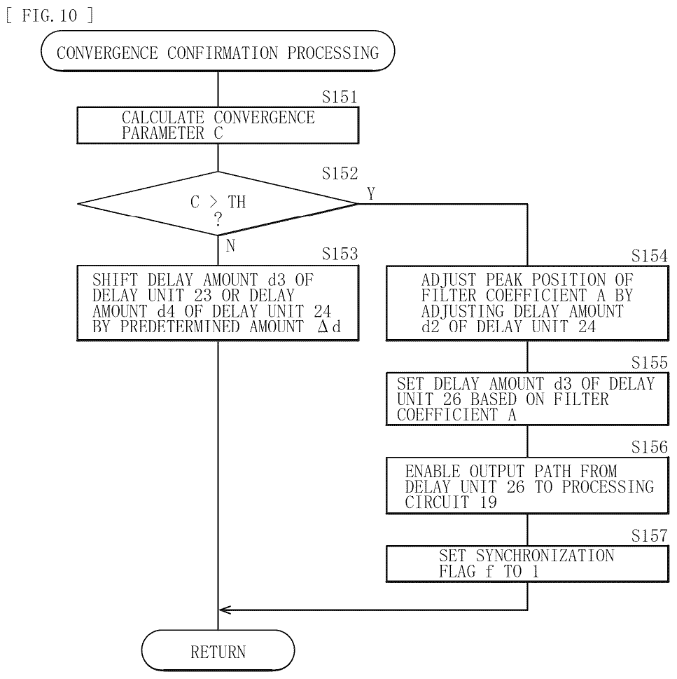

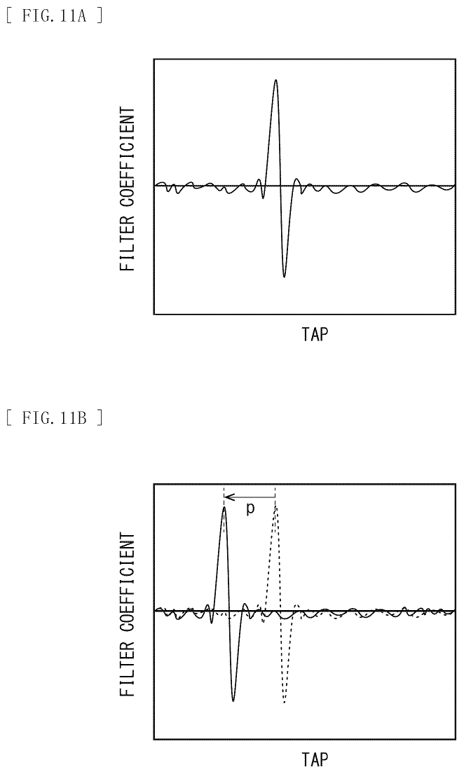

FIG. 10 illustrates an example of the convergence confirmation processing illustrated in Step S120 of FIG. 9C.

First, the adaptive algorithm processor 29 calculates the convergence parameter C indicating the degree of convergence (Step S151). Specifically, the adaptive algorithm processor 29 calculates the convergence parameter C, based on, for example, the result of the subtraction at the subtractor 27 over the standby time M up to a current time. In this example, the convergence parameter C is a parameter that increases in value as the convergence progresses.

Next, the adaptive algorithm processor 29 determines whether the convergence parameter C is greater than a predetermined threshold TH(C>TH) (Step S152).

When the convergence parameter C is determined not to be greater than the predetermined threshold TH in Step S152 (“N” in Step S152), the adaptive algorithm processor 29 shifts the delay amount d1 of the delayer 23 or the delay amount d2 of the delayer 24 by the predetermined amount Δd so that the phase difference between the signals S23 and S25 becomes small (Step S153). Specifically, the adaptive algorithm processor 29 searches for such delay amounts d1 and d2 that the convergence parameter C takes the maximum value. For example, when the phase of the signal S23 is delayed relative to the phase of the signal S25 as illustrated in Part (A) of FIG. 6, the adaptive algorithm processor 29 increases the delay amount d2 of the delayer 24 by the predetermined amount Δd as illustrated in Part (B) of FIG. 6. In contrast, when the phase of the signal S25 is delayed relative to the phase of the signal S23, the adaptive algorithm processor 29 reduces the delay amount d2 of the delayer 24 by the predetermined amount Δd. When the delay amount d2 of the delayer 24 is too small to reduce by the predetermined amount Δd, the adaptive algorithm processor 29 increases the delay amount d1 of the delayer 23 by the predetermined amount Δd. In this manner, the adaptive algorithm processor 29 adjusts the delay amount d1 of the delayer 23 or the delay amount d2 of the delayer 24 so that the phase difference between the signals S23 and S25 becomes small. Thereafter, the convergence confirmation processing illustrated in FIG. 10 ends.

When the convergence parameter C is determined to be greater than the predetermined threshold TH in Step S152 (“Y” in Step S152), the adaptive algorithm processor 29 adjusts the delay amount d2 of the delayer 24 first, to thereby adjust the peak position of the filter coefficient A (Step S154).

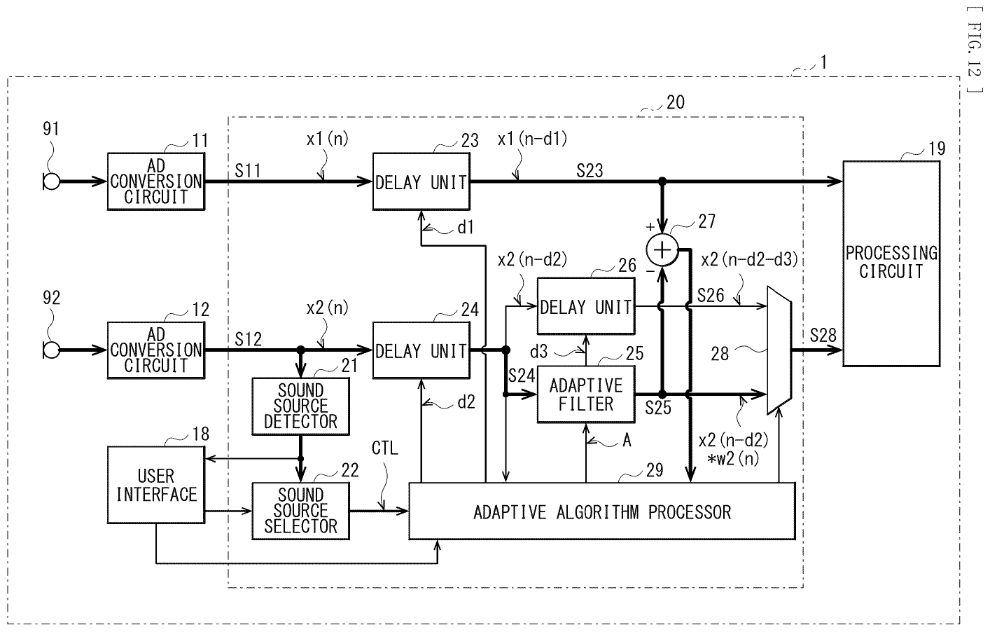

FIGS. 11A and 11B illustrate an adjustment operation of the peak position of the filter coefficient A. The adaptive algorithm processor 29 generates such a filter coefficient A of the adaptive filter 25 that the result of the subtraction at the subtractor 27 becomes small, based on the signal S24 inputted to the adaptive filter 25 and the result of the subtraction at the subtractor 27. As described above, the peak position of the filter coefficient A is desirably positioned at the position of about 1/4 from the left; however, the peak position can be shifted toward the vicinity of a lateral center as illustrated in FIG. 11A, for example. This can lower the convergence performance and synchronization accuracy of the signal synchronization circuit 20. Therefore, in such a case, the adaptive algorithm processor 29 increases the delay amount d2 of the delayer 24 by a delay amount p. With the increase in the delay amount d2 of the delayer 24, the result of the subtraction at the subtractor 27 increases transiently. To lower the result of the subtraction of the subtractor 27, the adaptive algorithm processor 29 generates such a filter coefficient A that the peak position of the filter coefficient A is shifted to the left by the delay amount p, as illustrated in FIG. 11B.

Specifically, the adaptive algorithm processor 29 may calculate, for example, an average value of absolute values of the filter coefficients A near a left end and an average value of absolute values of the filter coefficients A near a right end that are illustrated in FIG. 11A, and calculate such a delay amount p that these values are substantially equal to each other. Note that this is non-limiting, and the adaptive algorithm processor 29 may calculate a root mean square (RMS) value of the filter coefficients A near the left end and a RMS value of the filter coefficients A near of the right end, and calculate such a delay amount p that these values become substantially equal to each other. Further, the adaptive algorithm processor 29 may calculate the delay amount p by, for example, calculating a difference between the peak position and the 1/4 position from the left of the filter coefficient A illustrated in FIG. 11A. In this manner, the adaptive algorithm processor 29 adjusts the delay amount d2 of the delayer 24, to thereby adjust the peak position of the filter coefficient A.

Next, the adaptive algorithm processor 29 sets the delay amount d3 of the delayer 26, based on the filter coefficient A updated in Step S154 (Step S155).

Next, the adaptive algorithm processor 29 controls an operation of the selector 28 so that an output path from the delayer 26 to the processing circuit 19 is enabled (Step S156). Thereafter, the selector 28 supplies the data x2(n−d2−d3) outputted from the delayer 26 to the processing circuit 19.

Next, the adaptive algorithm processor 29 sets the synchronization flag f to “1” (Step S157).

The convergence confirmation processing (FIG. 10) thereby ends. Thereafter, the procedure returns to Step S105 as illustrated in FIG. 9C.

Next, the adaptive algorithm processor 29 determines whether the peak position of the filter coefficient A is outside a desired range (Step S121). As illustrated in FIG. 4, the peak position of the filter coefficient A is desirably positioned on the left side of the half, for example. This is why the adaptive algorithm processor 29 determines whether the peak position of the filter coefficient A is outside the desired range. When the peak position of the filter coefficient A is determined not to be outside the desired range (“N” in Step S121), the procedure proceeds to Step S123.

When the peak position of the filter coefficient A is determined to be outside the desired range in Step S121 (“Y” in Step S121), the adaptive algorithm processor 29 adjusts the peak position of the filter coefficient A by adjusting the delay amount d2 of the delayer 24 (Step S122). For example, the adaptive algorithm processor 29 adjusts the peak position of the filter coefficient A so that the peak position of the filter coefficient A is positioned at the position of about 1/4 from the left. This adjustment operation of the peak position is similar to the operation in Step S154 of FIG. 10 (FIGS. 11A and 11B).

Next, the adaptive algorithm processor 29 determines whether the processing is to be terminated (Step S123). For example, when the user performs an operation to terminate the processing by operating the user interface 18, the adaptive algorithm processor 29 determines that the processing is to be terminated. When the processing is determined not to be terminated (“N” in Step S123), the procedure returns to Step S105.

When the processing is determined to be terminated in Step S123 (“Y” in Step S123), the flow is terminated.

### (Operation Mode M2)

In the operation mode M2, the adaptive algorithm processor 29 causes the adaptive filter 25 to continuously operate, without causing the delayer 26 to operate, before and after the establishment of the synchronization. The adaptive algorithm processor 29 performs either the first processing or the second processing described below.

In the first processing, the adaptive algorithm processor 29 generates the filter coefficient A for both the phase processing and the amplitude processing and supplies the filter coefficient A to the adaptive filter 25 until the establishment of the synchronization. After the establishment of the synchronization, the adaptive algorithm processor 29 generates the filter coefficient A for both the phase processing and the amplitude processing and supplies the filter coefficient A to the adaptive filter 25.

In the second processing, the adaptive algorithm processor 29 generates the filter coefficient A for both the phase processing and the amplitude processing and supplies the filter coefficient A to the adaptive filter 25 until the establishment of the synchronization. After the establishment of the synchronization, the adaptive algorithm processor 29 generates the filter coefficient A for both the phase processing and the amplitude processing, converts the filter coefficient A into the filter coefficient B only for the phase processing, and supplies the filter coefficients A and B to the adaptive filter 25.

In the following, a description will be given first of a case where the first processing is performed, following which a description will be given of a case where the second processing is performed.

(Case where First Processing is Performed)

The case where the first processing is performed is described in detail below. An operation before the establishment of the synchronization is similar to that in the case of the operation mode M1 illustrated in FIGS. 5 to 7.

FIG. 12 illustrates an operation example of the signal synchronization circuit 20 after the establishment of the synchronization. The signal synchronization circuit 20 continuously performs the same operation as that before the establishment of the synchronization even after the establishment of the synchronization. That is, in this example, unlike in the operation mode M1, the delayer 26 is not operated, the adaptive algorithm processor 29 updates the filter coefficient A even after the establishment of the synchronization, and the adaptive filter 25 operates using the filter coefficient A.

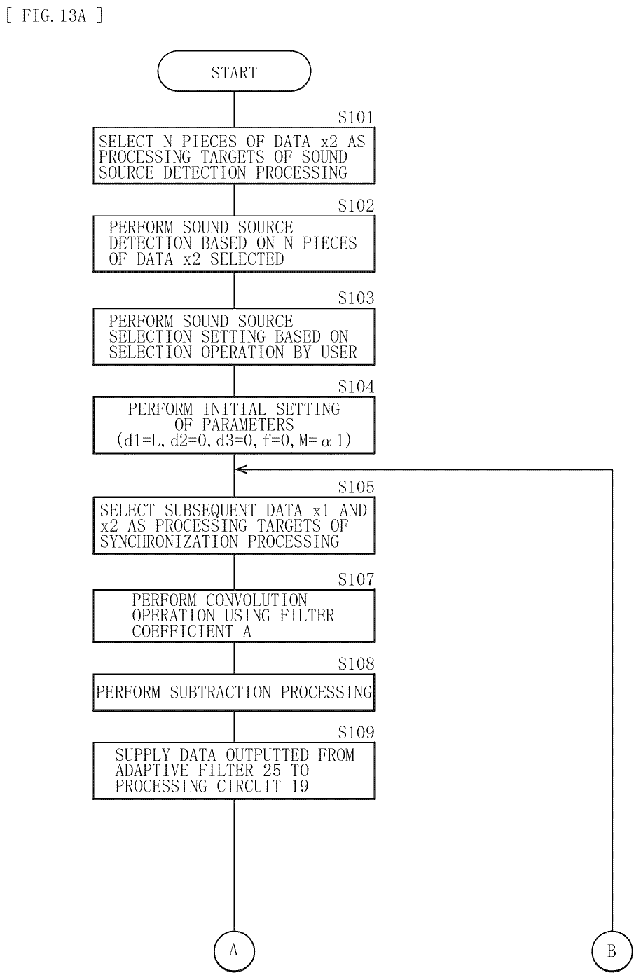

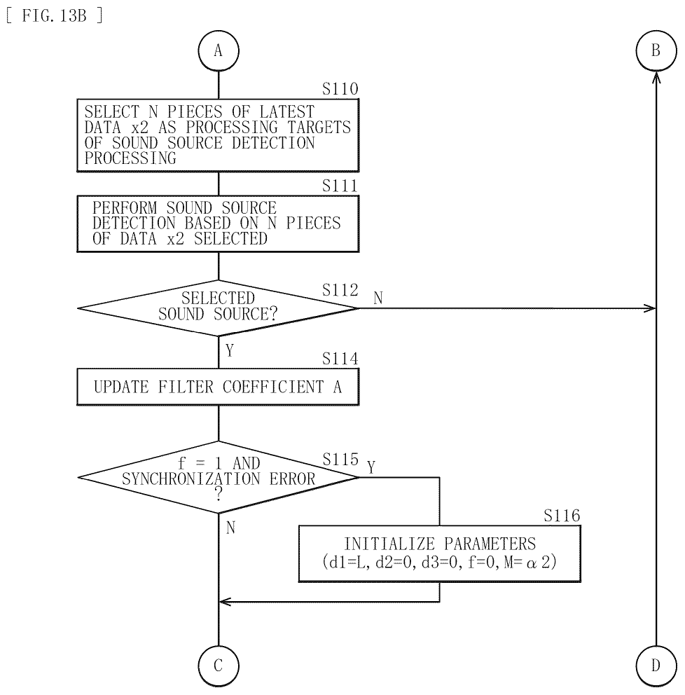

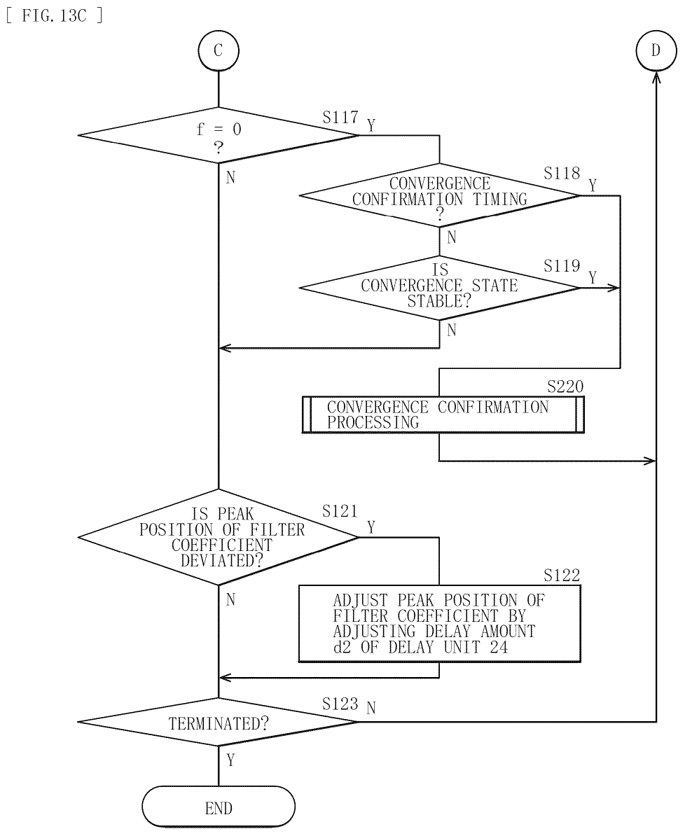

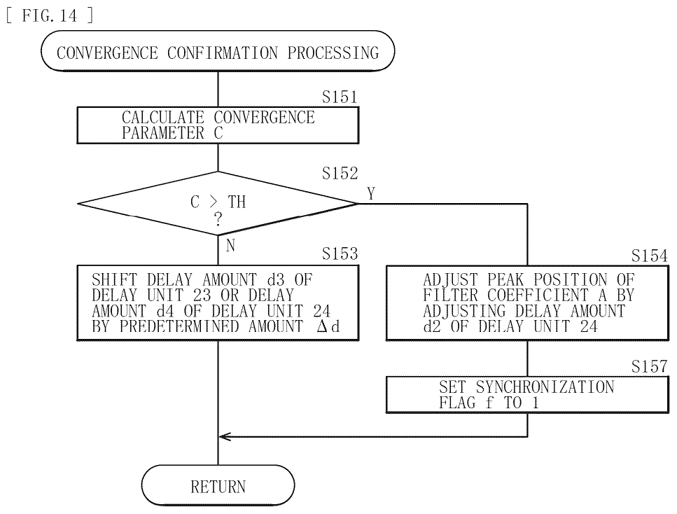

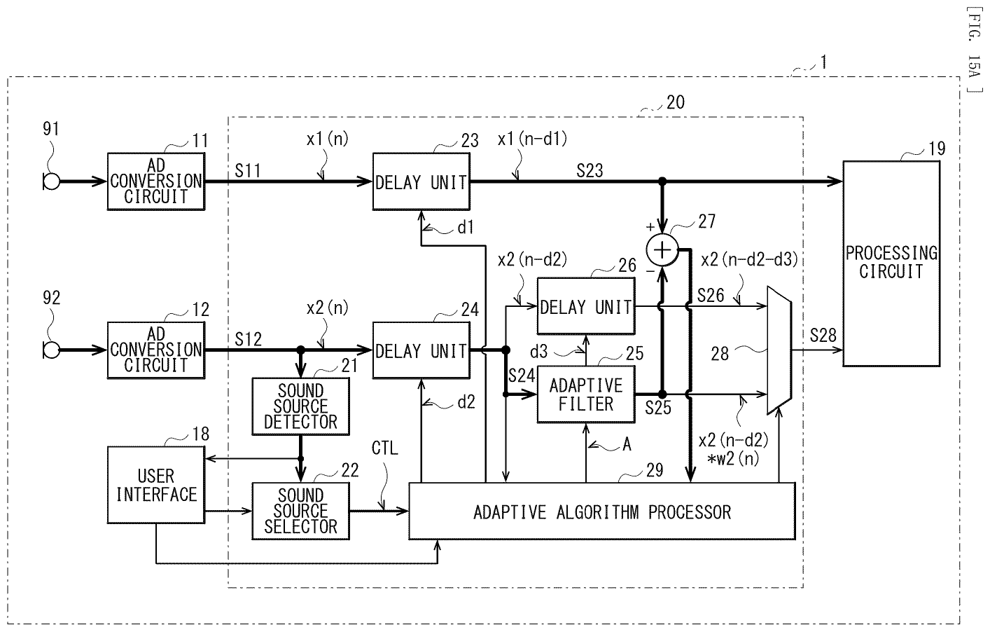

FIGS. 13A to 13C illustrate an operation example of the signal synchronization circuit 20. In this flowchart, Steps S106 and S113 in the case of the operation mode M1 illustrated in FIGS. 9A to 9C are omitted, and Step S120 is replaced with Step S220.

First, as in the case of the operation mode M1 illustrated in FIGS. 9A to 9C, the adaptive algorithm processor 29 selects N pieces of the data x2 having been sequentially supplied, as processing targets of the sound source detection processing (Step S101). The sound source detector 21 performs the sound source detection, based on the N pieces of the data x2 thus selected (Step S102), and the user interface 18 performs the sound source selection setting, based on the selection operation of the user (Step S103). Thereafter, the adaptive algorithm processor 29 performs the initial settings of the parameters (Step S104).

Next, the adaptive algorithm processor 29 selects the subsequent data x1 and x2 as processing targets of the synchronization processing (Step S105).

Next, the adaptive filter 25 performs the convolution operation using the filter coefficient A generated by the adaptive algorithm processor 29 (Step S107). For example, the adaptive algorithm processor 29 supplies the filter coefficient A having a predetermined value to the adaptive filter 25 first, and thereafter, the adaptive algorithm processor 29 supplies the filter coefficient A generated most recently to the adaptive filter 25. Based on the filter coefficient A supplied from the adaptive algorithm processor 29, the adaptive filter 25 performs the convolution operation.

Next, the subtractor 27 performs the subtraction processing (Step S108). Specifically, the subtractor 27 subtracts the data x2(n−d2)*w2(n) outputted from the adaptive filter 25 from the data x1(n−d1) outputted from the delayer 23.

Next, the selector 28 supplies the data x2(n−d2)*w2(n) outputted from the adaptive filter 25 to the processing circuit 19 (Step S109).

Next, as in the case of the operation mode M1 illustrated in FIGS. 9A to 9C, the adaptive algorithm processor 29 selects N pieces of the latest data x2 including the data x2 selected in Step S105 as processing targets of the sound source detection processing (Step S110), and the sound source detector 21 performs the sound source detection, based on the N pieces of data x2 thus selected (Step S111). Thereafter, the sound source selector 22 determines whether the sound source detected in Step S111 is the sound source selected in Step S103 (Step S112). When the detected sound source is determined not to be the selected sound source (“N” in Step S112), the procedure returns to Step S105.

When the detected sound source is determined to be the selected sound source in Step S112 (“Y” in Step S112), the adaptive algorithm processor 29 updates the filter coefficient A (Step S114). Specifically, the adaptive algorithm processor 29 updates the filter coefficient A of the adaptive filter 25, based on the signal S24 inputted to the adaptive filter 25 and the result of the subtraction at the subtractor 27 so that the result of the subtraction at the subtractor 27 becomes small.

Next, as in the case of the operation mode M1 illustrated in FIGS. 9A to 9C, the adaptive algorithm processor 29 determines whether the synchronization flag f is “1” (f=1) and whether a synchronization error has occurred (Step S115). When these conditions are determined not to be satisfied in Step S115 (“N” in Step S115), the procedure proceeds to Step S117. When these conditions are determined to be satisfied in Step S115 (“Y” in Step S115), the adaptive algorithm processor 29 initializes the parameters (Step S116).

Next, as in the case of the operation mode M1 illustrated in FIGS. 9A to 9C, the adaptive algorithm processor 29 determines whether the synchronization flag f is “0” (f=0) (Step S117). When the synchronization flag f is determined to be “1” (“N” in Step S117), the procedure proceeds to Step S121. When the synchronization flag f is determined to be “0” in Step S117 (“Y” in Step S117), the adaptive algorithm processor 29 determines whether the convergence confirmation timing has come (Step S118). When the convergence confirmation timing is determined to have come (“Y” in Step S118), the procedure proceeds to Step S220. When the convergence confirmation timing is determined not to have come (“N” in Step S118), the adaptive algorithm processor 29 determines whether the convergence state is stable (Step S119). When the convergence state is determined to be stable (“Y” in Step S119), the procedure proceeds to Step S220. When the convergence state is determined not to be stable (“N” in Step S119), the procedure proceeds to Step S121.

When the convergence confirmation timing is determined to have come in Step S118 (“Y” in Step S118) or when the convergence state is determined to be stable in Step S119 (“Y” in Step S119), the adaptive algorithm processor 29 performs the convergence confirmation processing (Step S220).

FIG. 14 illustrates an example of the convergence confirmation processing illustrated in Step S220 of FIG. 13C. In this flowchart, Steps S155 and S156 in the case of the operation mode M1 (FIG. 10) are omitted.

First, as in the case of the operation mode M1 (FIG. 10), the adaptive algorithm processor 29 calculates the convergence parameter C indicating the degree of convergence (Step S151). Thereafter, the adaptive algorithm processor 29 determines whether the convergence parameter C is greater than the predetermined threshold TH (C>TH) (Step S152). When the convergence parameter C is determined not to be greater than the predetermined threshold TH in Step S152 (“N” in Step S152), the adaptive algorithm processor 29 shifts the delay amount d1 of the delayer 23 or the delay amount d2 of the delayer 24 by the predetermined amount Δd so that the phase difference between the signals S23 and S25 becomes small (Step S153). Thereafter, the convergence confirmation processing (FIG. 14) ends.

When the convergence parameter C is determined to be greater than the predetermined threshold TH in Step S152 (“Y” in Step S152), the adaptive algorithm processor 29 adjusts the delay amount d2 of the delayer 24 first, to thereby adjust the peak position of the filter coefficient A (Step S154) as in the case of the operation mode M1 (FIG. 10).

Next, the adaptive algorithm processor 29 sets the synchronization flag f to “1” (Step S157).

The convergence confirmation processing (FIG. 14) thereby ends. Thereafter, the procedure returns to Step S105 as illustrated in FIG. 13C.

Subsequent processes, i.e., Steps S121 to S123 are similar to those in the case of the operation mode M1.

(Case where Second Processing is Performed)

The case where the second processing is performed is described in detail below. An operation before the establishment of the synchronization is similar to that in the case of the operation mode M1 illustrated in FIGS. 5 to 7.

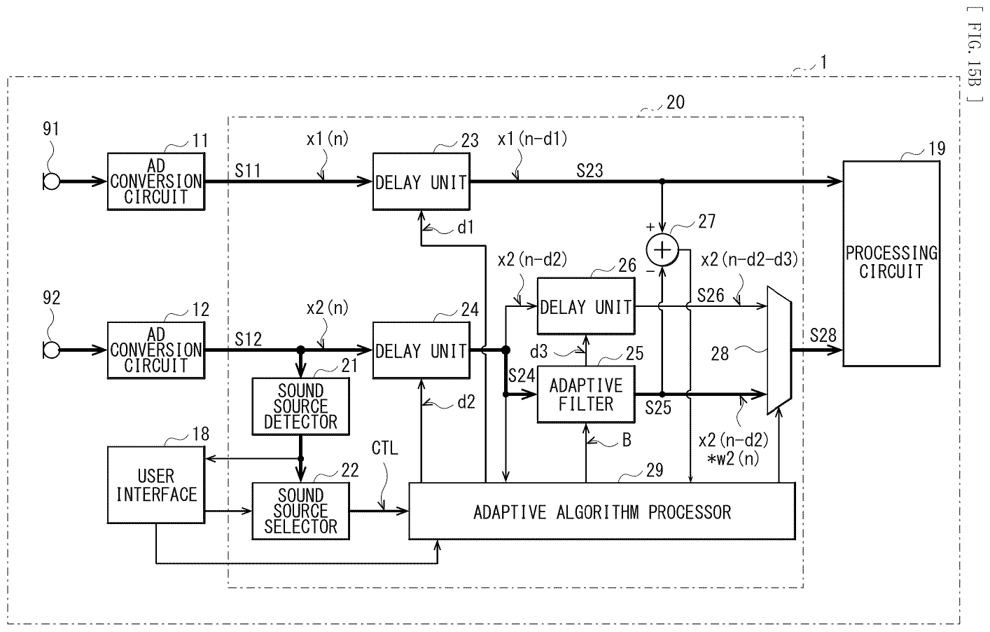

FIGS. 15A and 15B illustrate an operation example of the signal synchronization circuit 20 after the establishment of the synchronization. In each period corresponding to the sampling period Ts(=1/fs), the adaptive algorithm processor 29 generates such a filter coefficient A of the adaptive filter 25 that the result of the subtraction at the subtractor 27 becomes small, based on the signal S24 inputted to the adaptive filter 25 and the result of the subtraction at the subtractor 27. As illustrated in FIG. 15A, the adaptive filter 25 performs the filtering processing, based on the signal S24 supplied from the delayer 24 and using the filter coefficient A, to thereby generate the signal S25. Thereafter, the subtractor 27 performs the subtraction processing, based on the data generated by the adaptive filter 25, using the filter coefficient A. Further, the adaptive algorithm processor 29 converts the filter coefficient A into the filter coefficient B, and generates the signal S25 by performing the filtering processing, using the filter coefficient B and based on the signal S24 supplied from the delayer 24, as illustrated in FIG. 15B. The selector 28 supplies the data generated by the adaptive filter 25 using the filter coefficient B to the processing circuit 19. In this case, the data generated by the adaptive filter 25 using the filter coefficient B is not supplied to the subtractor 27.

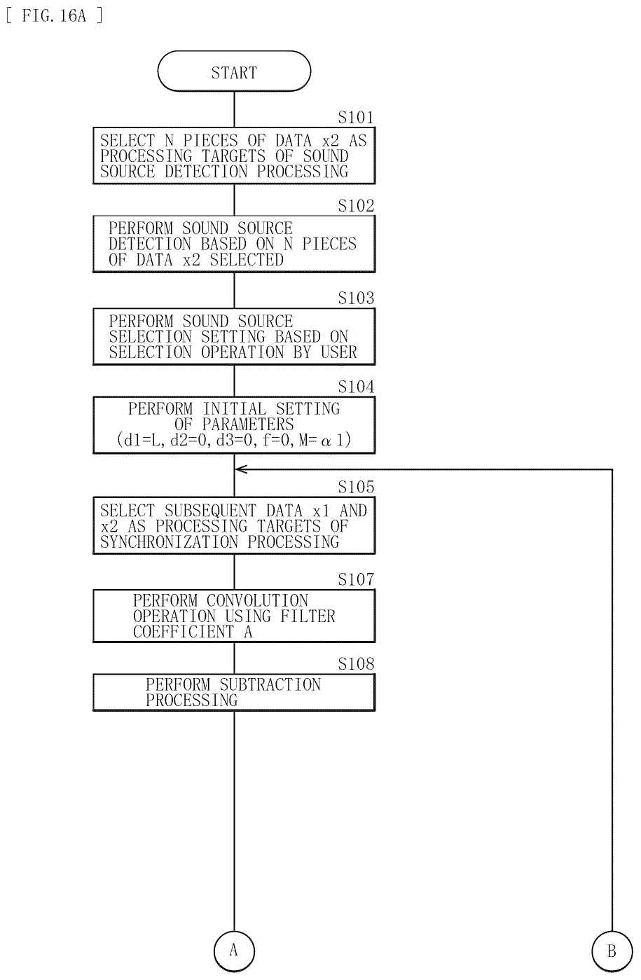

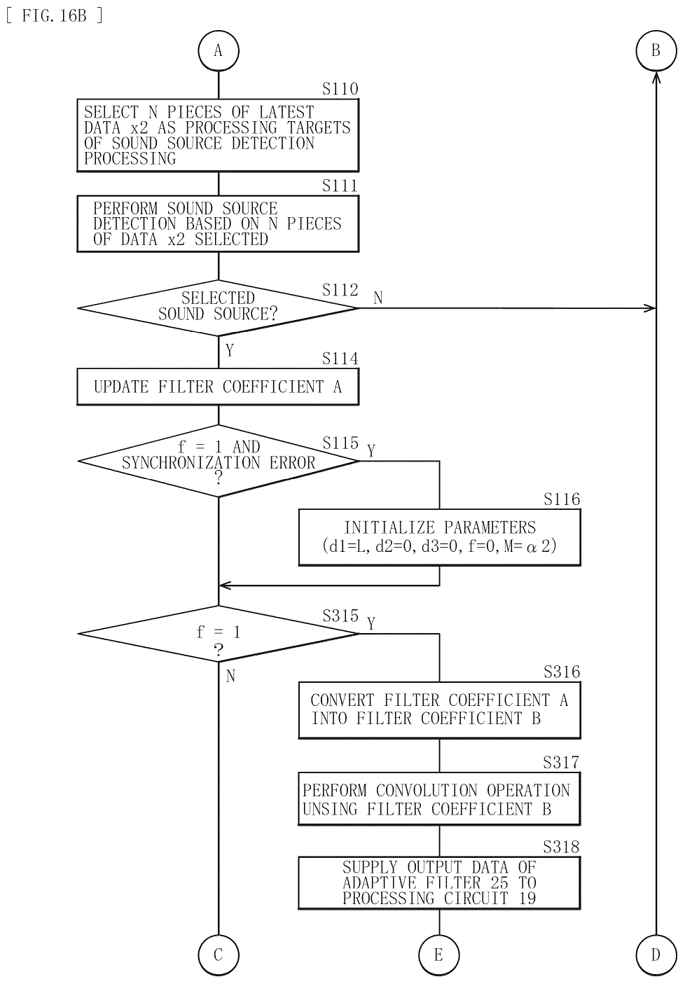

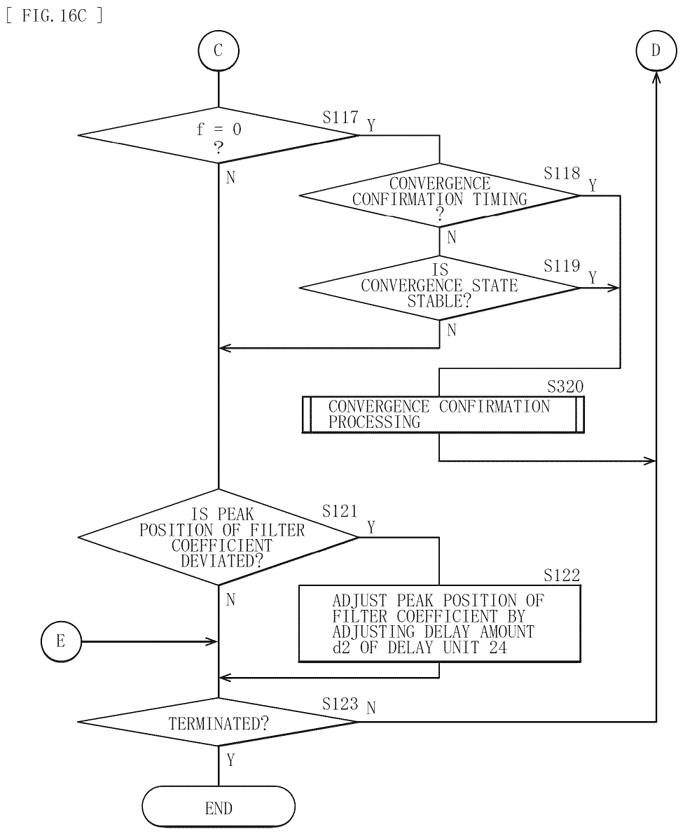

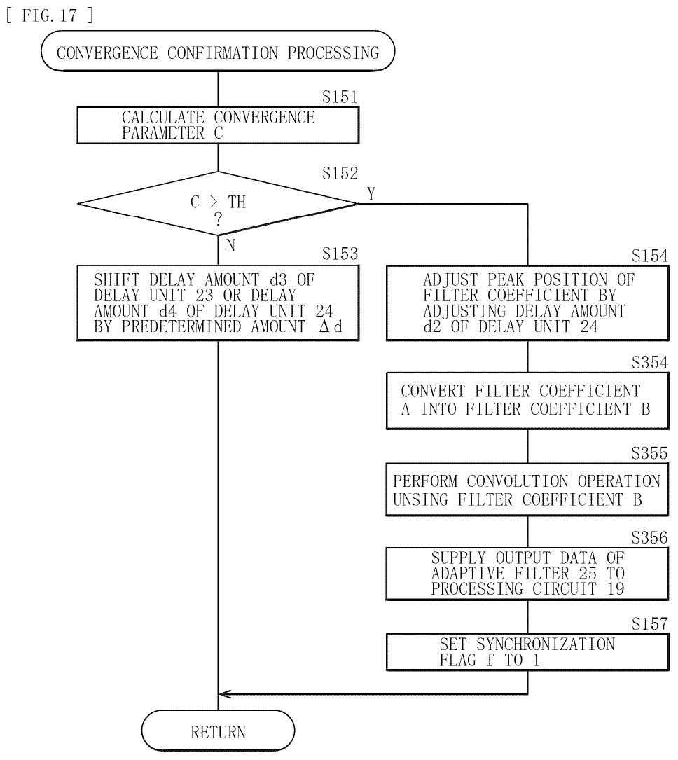

FIGS. 16A to 16C illustrate an operation example of the signal synchronization circuit 20. In this flowchart, Steps S106, S109, and S113 in the case of the operation mode M1 illustrated in FIGS. 9A to 9C are omitted, Steps S315 to S318 are added, and Step S120 is replaced with Step S320.

First, as in the case of the operation mode M1 illustrated in FIGS. 9A to 9C, the adaptive algorithm processor 29 selects N pieces of the data x2 having been sequentially supplied, as processing targets of the sound source detection processing (Step S101). The sound source detector 21 performs the sound source detection, based on the N pieces of the data x2 thus selected (Step S102), and the user interface 18 performs the sound source selection setting, based on the selection operation of the user (Step S103). Thereafter, the adaptive algorithm processor 29 performs the initial settings of the parameters (Step S104).

Next, the adaptive algorithm processor 29 selects the subsequent data x1 and x2 as processing targets of the synchronization processing (Step S105).

Next, the adaptive filter 25 performs a convolution operation using the filter coefficient A generated by the adaptive algorithm processor 29 (Step S107). For example, the adaptive algorithm processor 29 supplies the filter coefficient A having a predetermined value to the adaptive filter 25 first, and thereafter, the adaptive algorithm processor 29 supplies the filter coefficient A generated most recently to the adaptive filter 25. Based on the filter coefficient A supplied from the adaptive algorithm processor 29, the adaptive filter 25 performs the convolution operation.

Next, the subtractor 27 performs the subtraction processing (Step S108). Specifically, the subtractor 27 subtracts the data x2(n−d2)*w2(n) outputted from the adaptive filter 25 from the data x1(n−d1) outputted from the delayer 23.

Next, as in the case of the operation mode M1 illustrated in FIGS. 9A to 9C, the adaptive algorithm processor 29 selects N pieces of the latest data x2 including the data x2 selected in Step S105, as processing targets of the sound source detection processing (Step S110), and the sound source detector 21 performs the sound source detection, based on the N pieces of data x2 thus selected (Step S111). Thereafter, the sound source selector 22 determines whether the sound source detected in Step S111 is the sound source selected in Step S103 (Step S112). When the detected sound source is determined not to be the selected sound source (“N” in Step S112), the procedure returns to Step S105.

When the detected sound source is determined to be the selected sound source in Step S112 (“Y” in Step S112), the adaptive algorithm processor 29 updates the filter coefficient A (Step S114). Specifically, the adaptive algorithm processor 29 updates the filter coefficient A of the adaptive filter 25, based on the signal S24 inputted to the adaptive filter 25 and the result of the subtraction at the subtractor 27 so that the result of the subtraction at the subtractor 27 becomes small.

Next, as in the case of the operation mode M1 illustrated in FIGS. 9A to 9C, the adaptive algorithm processor 29 determines whether the synchronization flag f is “1” (f=1) and whether a synchronization error has occurred (Step S115). When these conditions are determined not to be satisfied in Step S115 (“N” in Step S115), the procedure proceeds to Step S315. When these conditions are determined to be satisfied in Step S115 (“Y” in Step S115), the adaptive algorithm processor 29 initializes the parameters (Step S116).

Next, the adaptive algorithm processor 29 determines whether the synchronization flag f is “1” (f=1) (Step S315).

When the synchronization flag f is determined to be “1” (f=1) in Step S315 (“Y” in Step S315), the adaptive algorithm processor 29 converts the filter coefficient A generated in Step S114 into the filter coefficient B (Step S316). That is, the adaptive algorithm processor 29 converts the filter coefficient A for both the phase processing and the amplitude processing into the filter coefficient B only for the phase processing. Specifically, the adaptive algorithm processor 29 may perform, for example, Fourier transform, based on the filter coefficient A, to thereby obtain a spectrum of the amplitude and a spectrum of the phase, convert the spectrum of the amplitude into a flat spectrum, and perform inverse Fourier transform, based on the spectrum of the phase and the converted spectrum of the amplitude, to thereby obtain the filter coefficient B.

Next, the adaptive filter 25 performs the convolution operation using the filter coefficient B generated by the adaptive algorithm processor 29 (Step S317).

Next, the selector 28 supplies the data x2(n−d2)*w2(n) outputted from the adaptive filter 25 to the processing circuit 19 (Step S318). Thereafter, the procedure proceeds to Step S123.

When the synchronization flag f is determined to be “0” in Step S315 (“N” in Step S315), the adaptive algorithm processor 29 determines whether the synchronization flag f is “0” (f=0) (Step S117). When the synchronization flag f is determined to be “1” (“N” in Step S117), the procedure proceeds to Step S121. When the synchronization flag f is determined to be “0” in Step S117 (“Y” in Step S117), the adaptive algorithm processor 29 determines whether the convergence confirmation timing has come (Step S118). When the convergence confirmation timing is determined to have come (“Y” in Step S118), the procedure proceeds to Step S320. When the convergence confirmation timing is determined not to have come in Step S118 (“N” in Step S118), the adaptive algorithm processor 29 determines whether the convergence state is stable (Step S119). When the convergence state is determined to be stable (“Y” in Step S119), the procedure proceeds to Step S320. When the convergence state is determined not to be stable (“N” in Step S119), the procedure proceeds to Step S121.

When the convergence confirmation timing is determined to have come in Step S118 (“Y” in Step S118) or when the convergence state is determined to be stable in Step S119 (“Y” in Step S119), the adaptive algorithm processor 29 performs the convergence confirmation processing (Step S320).

FIG. 17 illustrates an example of the convergence confirmation processing illustrated in Step S320 of FIG. 16C. In this flowchart, Steps S155 and S156 in the case of the operation mode M1 illustrated in FIG. 10 are omitted, and Steps S354 to S356 are added.

First, as in the case of the operation mode M1 (FIG. 10), the adaptive algorithm processor 29 calculates the convergence parameter C indicating the degree of convergence (Step S151). Thereafter, the adaptive algorithm processor 29 determines whether the convergence parameter C is greater than the predetermined threshold TH (C>TH) (Step S152). When the convergence parameter C is determined not to be greater than the predetermined threshold TH in Step S152 (“N” in Step S152), the adaptive algorithm processor 29 shifts the delay amount d1 of the delayer 23 or the delay amount d2 of the delayer 24 by the predetermined amount Δd so that the phase difference between the signals S23 and S25 becomes small (Step S153). Thereafter, the convergence confirmation processing (FIG. 14) ends.

When the convergence parameter C is determined to be greater than the predetermined threshold TH in Step S152 (“Y” in Step S152), the adaptive algorithm processor 29 adjusts the delay amount d2 of the delayer 24 first, to thereby adjust the peak position of the filter coefficientA (Step S154) as in the case of the operation mode M1 (FIG. 10).

Next, the adaptive algorithm processor 29 converts the filter coefficient A generated in Step S114 into the filter coefficient B (Step S354), and performs the convolution operation using the filter coefficient B generated by the adaptive algorithm processor 29 (Step S355). The selector 28 supplies the data x2(n−d2)*w2(n) outputted from the adaptive filter 25 to the processing circuit 19 (Step S356). This operation is similar to the operation in Steps S316 to S318.

Next, the adaptive algorithm processor 29 sets the synchronization flag f to “1” (Step S157).

The convergence confirmation processing (FIG. 17) thereby ends. Thereafter, the procedure returns to Step S105 as illustrated in FIG. 16C.

Subsequent processes, i.e., Steps S121 to S123 are similar to those in the case of the operation mode M1.

As described above, the signal synchronization circuit 20 has the operation modes M1 and M2. In the operation mode M2, the adaptive algorithm processor 29 of the signal synchronization circuit 20 may perform the first processing and the second processing. The user is allowed to select either the operation mode M1 or the operation mode M2 by operating the user interface 18. When the operation mode M2 is selected, the user is allowed to select either the first processing or the second processing.

In the operation mode M1, as described above, the adaptive algorithm processor 29 causes the adaptive filter 25 to operate until the establishment of the synchronization, and after the establishment of the synchronization, sets the delay amount d3 of the delayer 26, based on the filter coefficient A of the adaptive filter 25 to thereby cause the delayer 26, instead of the adaptive filter 25, to operate. Accordingly, in the operation mode M1, the adaptive filter 25 is not caused to operate after the establishment of the synchronization. This makes it possible to reduce a calculation amount. The operation mode M1 is effective in an application such as blind source separation (BSS) where a calculation amount is large and accurate synchronization is not required.

In the operation mode M2, as described above, the adaptive algorithm processor 29 causes the adaptive filter 25 to continuously operate, without causing the delayer 26 to operate, before and after the establishment of the synchronization. Accordingly, in the operation mode M2, the adaptive filter 25 is caused to operate after the establishment of the synchronization. This makes it possible to generate the signals S23 and S28 synchronized with each other even when the sound source has changed in its position or when the microphones 91 and 92 have changed in their characteristics due to environmental conditions, for example. This makes it possible to enhance the synchronization accuracy. The operation mode M2 is effective in an application such as beamforming or an adaptive noise canceller (ANC) where accurate phase synchronization is required.

In the operation mode M2, in the first processing, the signal synchronization circuit 20 may generate the signals S23 and S28 by performing the filtering processing in which both the amplitude and the phase of the signal S24 are adjusted, and may supply these signals S23 and S28 to the processing circuit 19. This makes it possible to achieve an adaptive noise canceller. In the second processing, the signal synchronization circuit 20 may generate the signals S23 and S28 by performing the filtering processing in which only the phase of the signal S24 is adjusted, and may supply these signals S23 and S28 to the processing circuit 19. This makes it possible to achieve ordinary signal synchronization.

The user may select either the operation mode M1 or the operation mode M2 and either the first processing or the second processing, depending on the application, considering the features of the operation mode M1 and M2 and the features of the first processing and the second processing.

As described above, the signal synchronization circuit 20 includes: the sound source detector 21 that detects the sound source, based on a second signal (the signal S12) out of a first signal (the signal S11) supplied from a first microphone (the microphone 91) and the second signal (the signal S12) supplied from a second microphone (the microphone 92); the sound source selector 22 that sets the processing period T, based on the result of detecting by the sound source detector 21; the first delayer (the delayer 23) that delays the first signal (the signal S11); the second delayer (the delayer 24) that delays the second signal (the signal S12); the adaptive filter 25 that generates a third signal (the signal S25) by performing the filtering processing, based on the second signal delayed by the second delayer; and the adaptive algorithm processor 29 that controls the operations of the first delayer (the delayer 23), the second delayer (the delayer 24), and the adaptive filter 25 in the processing period T so that the signal difference between the first signal delayed by the first delayer (the delayer 23) and the third signal (the signal S25) becomes small. Accordingly, when a phase difference occurs between the signals S11 and S12, based on a difference in arrival time of the sound wave or when a phase difference occurs between the signals S11 and S12 due to a difference in characteristic between the microphone 91 and the microphone 92, for example, it is possible to perform signal synchronization more accurately with a small calculation amount.

That is, when multiple signals are synchronized using a cross-correlation function as in the technique disclosed in PTL 1, for example, a calculation amount inevitably increases. Further, the calculation using the cross-correlation function is performed based on data corresponding to a relatively long time, which makes it difficult to perform real-time processing in a short time. If the processing is performed in a short time with a reduced calculation amount, accuracy of the signal synchronization is lowered.

In contrast, in the signal synchronization circuit 20, the delayers 23 and 24 and the adaptive filter 25 are provided. This allows the delayers 23 and 24 to perform the coarse adjustment, and the adaptive filter 25 to perform the fine adjustment in the signal synchronization circuit 20, for example. It is therefore possible to reduce the calculation amount and enhance the accuracy of the signal synchronization as compared with a case where only the delayer is used or a case where only the adaptive filter is used, for example. As a result, the signal synchronization circuit 20 makes it possible to perform real-time processing in a short time.

Further, in the signal synchronization circuit 20, the sound source detector 21 generates a sequence of the meta-data indicating the kind of the sound source by detecting the sound source, based on the second signal (signal S12) supplied from the second microphone (the microphone 92), and the sound source selector 22 sets the processing period T, based on the sequence of the meta-data. At this time, when the S/N ratio of the signal component included in the second signal (the signal S12) supplied from the second microphone (the microphone 92) is greater than the predetermined value, the sound source detector 21 detects the sound source, based on the signal component. Accordingly, the signal synchronization circuit 20 makes it possible to reduce a possibility of performing the signal synchronization based on an unintended signal. This makes it possible to enhance the accuracy of the signal synchronization.

Further, in the signal synchronization circuit 20, the sound source selector 22 sets the processing period T, based on the result of detecting by the sound source detector 21 and the sound source selection operation of the user received by the user interface 18. The user is allowed to select what sound source the synchronization is to be performed with, depending on the application. Therefore, the signal synchronization circuit 20 makes it possible to perform the signal synchronization based on a signal intended by the user. This makes it possible to enhance the accuracy of the signal synchronization.

Further, in the signal synchronization circuit 20, the adaptive algorithm processor 29 sets an initial value of the delay amount of the first delayer (the delayer 23) to the predetermined amount L corresponding to the adaptive filter 25, and thereafter, in the processing period T, sequentially generates the filter coefficient of the adaptive filter 25, based on the second signal delayed by the second delayer (the delayer 24) and the signal difference, and causes the adaptive filter 25 to perform the filtering processing. Thereafter, the adaptive algorithm processor 29 determines the convergence state of the signal difference, and, when the signal difference is determined not to have converged, changes the delay amount d1 of the first delayer (the delayer 23), the delay amount d2 of the second delayer (the delayer 24), or both. Accordingly, in the signal synchronization circuit 20, the delayers 23 and 24 are allowed to perform the coarse adjustment, and the adaptive filter 25 is allowed to perform the fine adjustment, for example. As a result, the signal synchronization circuit 20 makes it possible to enhance the accuracy of the signal synchronization.

Further, in the signal synchronization circuit 20, the delay amount d1 of the first delayer (the delayer 23), the delay amount d2 of the second delayer (the delayer 24), and the filter coefficient are maintained in periods other than the processing period T. This prevents the signal synchronization from being performed based on an unintended sound source, and therefore makes it possible to enhance the synchronization accuracy.

### [Effects]

As described above, provided in the present example embodiment are: the sound source detector that detects a sound source, based on the second signal out of the first signal supplied from the first microphone and the second signal supplied from the second microphone; the sound source selector that sets the processing period, based on the result of detecting by the sound source detector; the first delayer that delays the first signal; the second delayer that delays the second signal; the adaptive filter 25 that generates the third signal by performing the filtering processing, based on the second signal delayed by the second delayer; and the adaptive algorithm processor 29 that controls the operations of the first delayer, the second delayer, and the adaptive filter 25 in the processing period so that the signal difference between the first signal delayed by the first delayer and the third signal becomes small. It is therefore possible to perform the signal synchronization more accurately with a small calculation amount.

In the present example embodiment, the sound source detector generates the sequence of the meta-data indicating the kind of the sound source by detecting the sound source, based on the second signal supplied from the second microphone, and the sound source selector sets the processing period, based on the sequence of the meta-data. At this time, when the S/N ratio of the signal component included in the second signal supplied from the second microphone is greater than the predetermined value, the sound source detector detects the sound source, based on the signal component. This makes it possible to enhance the accuracy of the signal synchronization.

In the present example embodiment, the sound source selector sets the processing period, based on the result of detecting by the sound source detector and the sound source selection operation of the user received by the user interface. This makes it possible to perform the signal synchronization based on a signal intended by the user. Accordingly, it is possible to enhance the accuracy of the signal synchronization.

In the present example embodiment, after the adaptive algorithm controller has set the initial value of the delay amount of the first delayer to the predetermined amount corresponding to the adaptive filter, the adaptive algorithm controller sequentially generates the filter coefficient of the adaptive filter in the processing period, based on the second signal delayed by the second delayer and the signal difference, and causes the adaptive filter to perform the filtering processing in the processing period. Thereafter, the adaptive algorithm controller determines the convergence state of the signal difference, and changes the delay amount of the first delayer, the delay amount of the second delayer, or both when the signal difference is determined not to have converged. This makes it possible to enhance the accuracy of the signal synchronization.

In the present example embodiment, the delay amount of the first delayer, the delay amount of the second delayer, and the filter coefficient are maintained in the periods other than the processing period. This makes it possible to prevent the signal synchronization from being performed based on an unintended sound source. Accordingly, it is possible to enhance the synchronization accuracy.

### Modification Example 1

In the foregoing example embodiment, in the first operation mode, the adaptive algorithm processor 29 stops updating the filter coefficient A upon the establishment of the synchronization as illustrated in FIGS. 9A to 9C; however, this is non-limiting. Alternatively, the adaptive algorithm processor 29 may intermittently update the filter coefficient A, for example. This operation will be described in detail below.

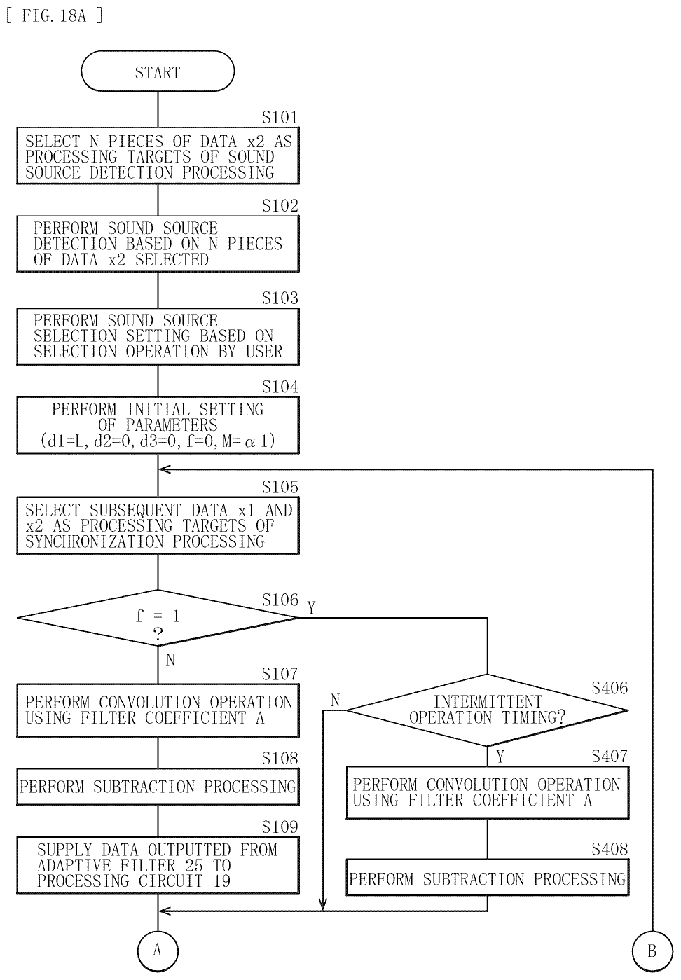

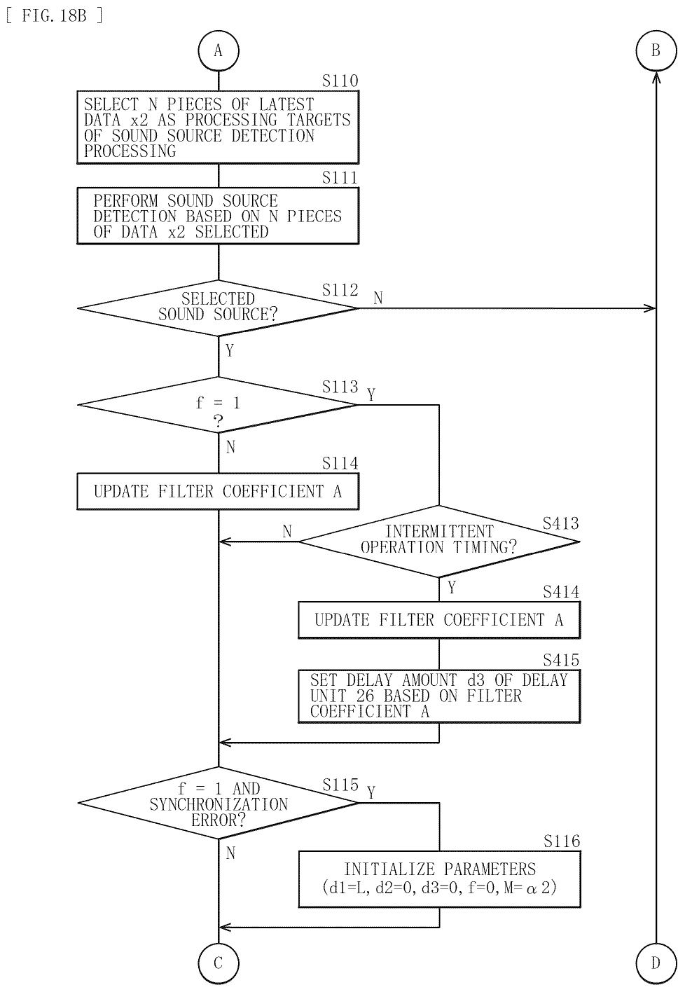

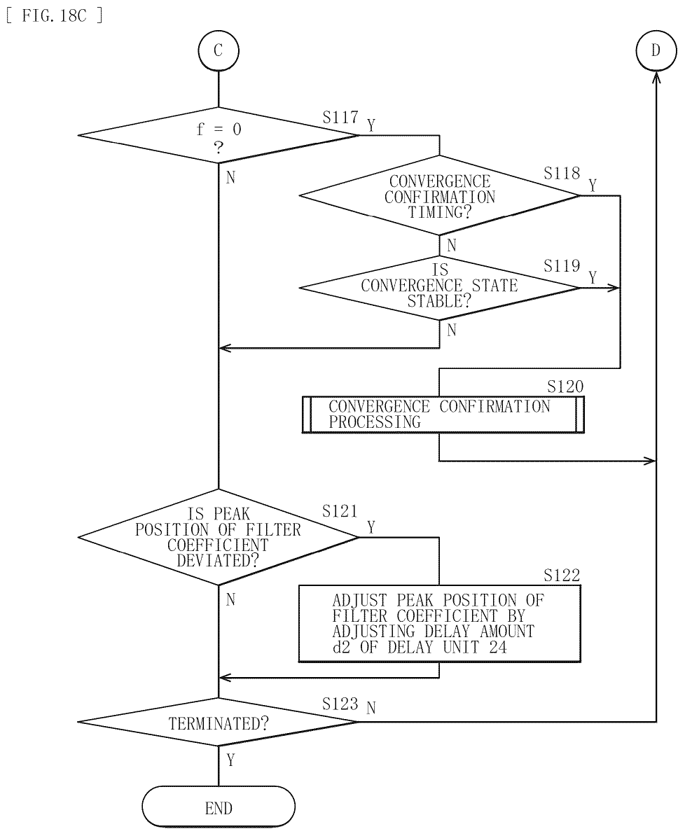

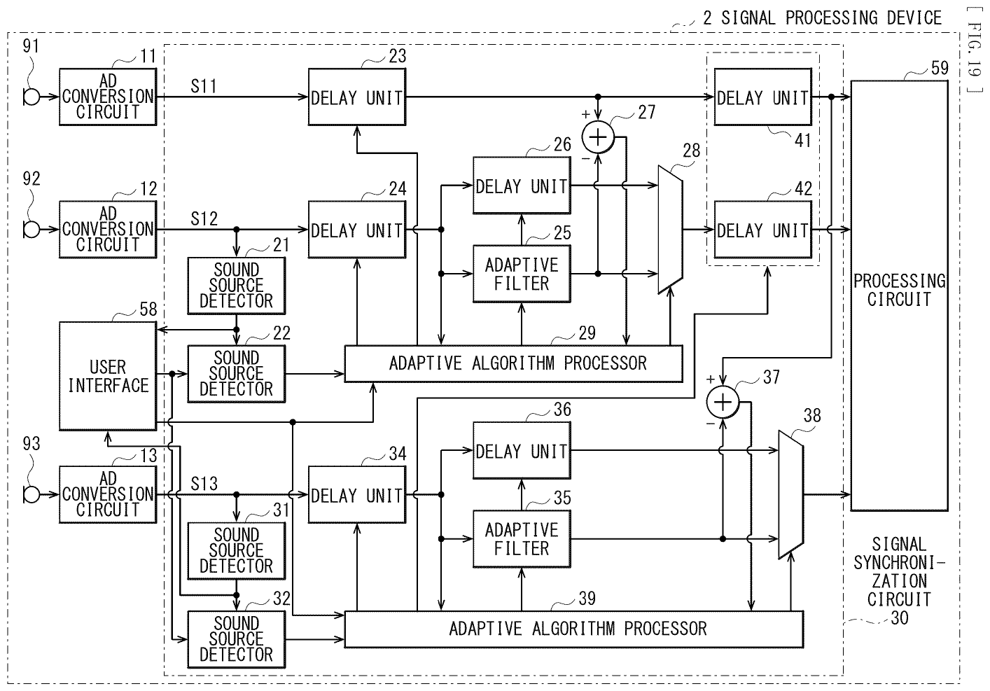

FIGS. 18A to 18C illustrate an operation example of the signal synchronization circuit 20 in the operation mode M1. In this flowchart, Steps S406 to S408 and S413 to S416 are added to the flowchart in the operation mode M1 illustrated in FIGS. 9A to 9C.

When the synchronization flag f is determined to be “1” in Step S106 (“Y” in Step S106), the adaptive algorithm processor 29 determines whether an intermittent operation timing has come (Step S406). Specifically, the adaptive algorithm processor 29 determines that the intermittent operation timing has come when a predetermined time, which is, for example, one second, has elapsed since the synchronization flag f has become “1” or when a predetermined time, which is, for example, one second, has elapsed since the previous intermittent operation, for example. When the intermittent operation timing is determined not to have come (“N” in Step S406), the procedure proceeds to Step S110.

When the intermittent operation timing is determined to have come in Step S406 (“Y” in Step S406), the adaptive filter 25 performs the convolution operation using the filter coefficient A generated by the adaptive algorithm processor 29 (Step S407), and the subtractor 27 performs the subtraction processing (Step S408). Thereafter, the procedure proceeds to Step S110.

When the synchronization flag f is determined to be “1” in Step S113 (“Y” in Step S113), the adaptive algorithm processor 29 determines whether the intermittent operation timing has come (Step S406). When the intermittent operation timing is determined not to have come (“N” in Step S406), the procedure proceeds to Step S115.

When the intermittent operation timing is determined to have come in Step S413 (“Y” in Step S413), the adaptive algorithm processor 29 updates the filter coefficient A (Step S414), and sets the delay amount d3 of the delayer 26, based on the filter coefficient A (Step S415). Thereafter, the procedure proceeds to Step S115.

### Modification Example 2

In the foregoing example embodiment, the signal synchronization circuit 20 is operatable in both the operation mode M1 and the operation mode M2; however, this is non-limiting. For example, the signal synchronization circuit 20 may be operatable only in the operation mode M1 or only in the operation mode M2. Further, the adaptive algorithm processor 29 is configured to perform both the first processing and the second processing when the signal synchronization circuit 20 operates in the operation mode M2; however, this is non-limiting. For example, the adaptive algorithm processor 29 may perform only the first processing or only the second processing.

### Other Modification Examples

Further, two or more of these modification examples may be combined.

The disclosure has been described hereinabove with reference to the example embodiments and the modification examples. However, the disclosure is not limited to these example embodiments, etc., and may be modified in a variety of ways.

For example, in the foregoing example embodiments, etc., the two microphones 91 and 92 are provided; however, this is non-limiting. Alternatively, three or more microphones may be provided. FIG. 19 illustrates a configuration example of a signal processing device 2 in a case where three microphones are provided. The signal processing device 2 includes a microphone 93, an AD conversion circuit 13, a user interface 58, a signal synchronization circuit 30, and a processing circuit 59. Like the microphones 91 and 92, the microphone 93 is configured to convert a sound wave into an electric signal. Like the AD conversion circuits 11 and 12, the AD conversion circuit 13 is configured to perform AD conversion, based on the electric signal supplied from the microphone 93, to thereby generate a signal S13. The user interface 58 is configured to present information to a user of the signal processing device 2 and receive a user operation. The signal synchronization circuit 30 is configured to synchronize the signals S11 to S13. The signal synchronization circuit 30 illustrated in FIG. 19 includes delayers 41 and 42, a sound source detector 31, a sound source selector 32, a delayer 34, an adaptive filter 35, a delayer 36, a subtractor 37, a selector 38, and an adaptive algorithm processor 39. The delayer 41 is configured to delay a signal supplied from the delayer 23. The delayer 42 is configured to delay a signal supplied from the selector 28. A delay amount of the delayer 41 and a delay amount of the delayer 42 are the same, and these delay amounts are set by the adaptive algorithm processor 39. The sound source detector 31, the sound source selector 32, the delayer 34, the adaptive filter 35, the delayer 36, the subtractor 37, the selector 38, and the adaptive algorithm processor 39 correspond to the sound source detector 21, the sound source selector 22, the delayer 24, the adaptive filter 25, the delayer 26, the subtractor 27, the selector 28, and the adaptive algorithm processor 29, respectively. Like the adaptive algorithm processor 29, the adaptive algorithm processor 39 is configured to control operations of the delayers 41, 42, and 34, and the adaptive filter 35 by performing the adaptive algorithm processing. The processing circuit 59 is configured to perform predetermined signal processing, based on the three signals supplied from the signal synchronization circuit 30.

Embodiments of the disclosure may be configured as follows.

(1)

A signal synchronization circuit including:
a detector configured to detect a sound source, based on a second signal out of a first signal supplied from a first microphone and the second signal supplied from a second microphone;
a setter configured to set a processing period, based on a result of detecting by the detector;
a first delayer configured to delay the first signal;
a second delayer configured to delay the second signal;
a filter configured to generate a third signal by performing filtering processing, based on the second signal delayed by the second delayer; and
a controller configured to control operations of the first delayer, the second delayer, and the filter in the processing period to cause a signal difference between the first signal delayed by the first delayer and the third signal to become small.
   (2)

The signal synchronization circuit according to (1), in which
the detector is configured to generate a sequence of meta-data by detecting the sound source, based on the second signal supplied from the second microphone, the meta-data indicating a kind of the sound source, and
the setter is configured to set the processing period, based on the sequence of the meta-data.
   (3)

The signal synchronization circuit according to (2), in which, when a S/N ratio of a signal component included in the second signal supplied from the second microphone is greater than a predetermined value, the detector is configured to detect the sound source, based on the signal component.

(4)

The signal synchronization circuit according to any one of (1) to (3), in which the setter is configured to set the processing period, based on the result of detecting by the detector and a sound source selection operation of a user received by a user interface.

(5)

The signal synchronization circuit according to any one of (1) to (4), in which,
after the controller has set an initial value of a delay amount of the first delayer to a predetermined amount corresponding to the filter,
the controller is configured to
sequentially generate a filter coefficient of the filter in the processing period, based on the second signal delayed by the second delayer and the signal difference, and cause the filter to perform the filtering processing in the processing period,
determine a convergence state of the signal difference, and
change the delay amount of the first delayer, a delay amount of the second delayer, or both when the signal difference has not converged.
   (6)

The signal synchronization circuit according to (5), in which the controller is configured to maintain the delay amount of the first delayer, the delay amount of the second delayer, and the filter coefficient in a period other than the processing period.

(7)

The signal synchronization circuit according to (5) or (6), in which
the filter coefficient includes multiple coefficients respectively corresponding to multiple orders of the filter, and
the controller is configured to adjust the delay amount of the second delayer, based on the filter coefficient when the signal difference has converged.
   (8)

The signal synchronization circuit according to (7), in which, when the signal difference has converged, the controller is configured to adjust the delay amount of the second delayer to cause a peak position of the filter coefficient to be positioned within a predetermined range.

(9)

The signal synchronization circuit according to (7), in which the controller is configured to adjust the delay amount of the second delayer, based on two or more coefficients near a first end and two or more coefficients near a second end among the multiple coefficients included in the filter coefficient.

(10)

The signal synchronization circuit according to any one of (5) to (9), further including
a third delayer configured to delay the second signal delayed by the second delayer, in which
the filter coefficient includes multiple coefficients respectively corresponding to multiple orders of the filter, and
the controller is configured to
cause the filter to operate and supply the first signal delayed by the first delayer and the third signal to a post-stage circuit before the signal difference converges,
set a delay amount of the third delayer to a delay amount corresponding to the filter coefficient when the signal difference has converged, and
restrict the operation of the filter and supply the first signal delayed by the first delayer and the second signal delayed by the third delayer to the post-stage circuit after the signal difference converges.
   (11)

The signal synchronization circuit according to any one of (5) to (9), in which the controller is configured to
cause the filter to operate before the signal difference converges, and
cause the filter to continuously operate after the signal difference converges.
   (12)

The signal synchronization circuit according to any one of (5) to (9), further including
a third delayer configured to delay the second signal delayed by the second delayer, in which
the filter coefficient includes multiple coefficients respectively corresponding to multiple orders of the filter,
the controller is operable in a selected operation mode out of a first operation mode and a second operation mode,
in the first operation mode, the controller is configured to
cause the filter to operate before the signal difference converges,
set a delay amount of the third delayer to a delay amount corresponding to the filter coefficient when the signal difference has converged, and
restrict the operation of the filter after the signal difference converges, and
in the second operation mode, the controller is configured to
cause the filter to operate before the signal difference converges, and
cause the filter to continuously operate after the signal difference converges.
   (13)

The signal synchronization circuit according to (11), in which the filter is configured to selectively perform first filtering processing in which both a phase and an amplitude are adjusted and second filtering processing in which the phase is adjusted.

(14)

The signal synchronization circuit according to (13), in which the controller is configured to cause the filter to perform the first filtering processing both before and after the signal difference converges.

(15)

The signal synchronization circuit according to (13), in which,
before the signal difference converges, the controller is configured to cause the filter to perform the first filtering processing, acquire the signal difference corresponding to a processing result of the first filtering processing, and supply the third signal to a post-stage circuit, and,
after the signal difference converges, the controller is configured to cause the filter to perform the first filtering processing and acquire the signal difference corresponding to the processing result of the first filtering processing, and thereafter, cause the filter to perform the second filtering processing and supply the third signal obtained through the second filtering processing to the post-stage circuit.
   (16)

The signal synchronization circuit according to (13), in which
the controller is configured to perform selected processing out of first processing and second processing,
in the first processing, both before and after the signal difference converges, the controller is configured to cause the filter to perform the first filtering processing, acquire the signal difference corresponding to a processing result of the first filtering processing, and supply the third signal obtained through the first filtering processing to a post-stage circuit, and
in the second processing,
before the signal difference converges, the controller is configured to cause the filter to perform the first filtering processing, acquire the signal difference corresponding to the processing result of the first filtering processing, and supply the third signal obtained through the first filtering processing to the post-stage circuit, and
after the signal difference converges, the controller is configured to cause the filter to perform the first filtering processing and acquire the signal difference corresponding to the processing result of the first filtering processing, and thereafter, cause the filter to perform the second filtering processing and supply the third signal obtained through the second filtering processing to the post-stage circuit.
   (17)

The signal synchronization circuit according to any one of (5) to (16), in which
the filter coefficient includes multiple coefficients respectively corresponding to multiple orders of the filter, and
after the signal difference converges, the controller is configured to monitor whether a peak position of the filter coefficient is positioned within a predetermined range and adjust the delay amount of the second delayer to cause the peak position to be positioned within the predetermined range.
   (18)

The signal synchronization circuit according to any one of (1) to (17), in which the controller is configured to detect a synchronization state in the signal synchronization circuit, and, when a synchronization error has occurred, set a delay amount of the first delayer and a delay amount of the second delayer to initial values and control the operations of the first delayer, the second delayer, and the filter to cause the signal difference to become small.

(19)

A signal processing device including:
a signal synchronization circuit configured to generate two signals by performing signal synchronization processing, based on a first signal supplied from a first microphone and a second signal supplied from a second microphone, the two signals corresponding to the first signal and the second signal and being synchronized with each other; and
a processing circuit configured to perform signal processing, based on the two signals, in which
the signal synchronization circuit includes
   a detector configured to detect a sound source, based on the second signal,
   a setter configured to set a processing period, based on a result of detecting by the detector,
   a first delayer configured to delay the first signal,
   a second delayer configured to delay the second signal,
   a filter configured to generate a third signal by performing filtering processing, based on the second signal delayed by the second delayer, and
   a controller configured to control operations of the first delayer, the second delayer, and the filter in the processing period to cause a signal difference between the first signal delayed by the first delayer and the third signal to become small.
      (20)

A signal synchronization method including:
detecting a sound source, based on a second signal out of a first signal supplied from a first microphone and the second signal supplied from a second microphone;
setting a processing period, based on a result of detecting the sound source;
delaying the first signal with a first delayer;
delaying the second signal with a second delayer;
generating a third signal by performing filtering processing with a filter, based on the second signal delayed by the second delayer; and
controlling operations of the first delayer, the second delayer, and the filter in the processing period to cause a signal difference between the first signal delayed by the first delayer and the third signal to become small.
   (21)

A non-transitory computer readable recording medium containing software, the software being configured to cause a processor to
detect a sound source, based on a second signal out of a first signal supplied from a first microphone and the second signal supplied from a second microphone,
set a processing period, based on a result of detecting the sound source,
delay the first signal with a first delayer,
delay the second signal with a second delayer,
generate a third signal by performing filtering processing with a filter, based on the second signal delayed by the second delayer, and
control operations of the first delayer, the second delayer, and the filter in the processing period to cause a signal difference between the first signal delayed by the first delayer and the third signal to become small.

The signal synchronization circuit, the signal processing device, the signal synchronization method, and the non-transitory recording medium according to at least one embodiment of the disclosure each make it possible to perform, more accurately with a small calculation amount, synchronization of a plurality of signals obtained by a plurality of microphones.

1-21. (canceled)

22. A signal synchronization circuit comprising:
a detector configured to detect a sound source, based on a second signal out of a first signal supplied from a first microphone and the second signal supplied from a second microphone;
a setter configured to set a processing period, based on a result of detecting by the detector;
a first delayer configured to delay the first signal;
a second delayer configured to delay the second signal;
a filter configured to generate a third signal by performing filtering processing, based on the second signal delayed by the second delayer; and
a controller configured to control operations of the first delayer, the second delayer, and the filter in the processing period to cause a signal difference between the first signal delayed by the first delayer and the third signal to become small.

23. The signal synchronization circuit according to claim 22, wherein
the detector is configured to generate a sequence of meta-data by detecting the sound source, based on the second signal supplied from the second microphone, the meta-data indicating a kind of the sound source, and
the setter is configured to set the processing period, based on the sequence of the meta-data.

24. The signal synchronization circuit according to claim 23, wherein, when a S/N ratio of a signal component included in the second signal supplied from the second microphone is greater than a predetermined value, the detector is configured to detect the sound source, based on the signal component.

25. The signal synchronization circuit according to claim 22, wherein the setter is configured to set the processing period, based on the result of detecting by the detector and a sound source selection operation of a user received by a user interface.

26. The signal synchronization circuit according to claim 22, wherein,
after the controller has set an initial value of a delay amount of the first delayer to a predetermined amount corresponding to the filter,
the controller is configured to
sequentially generate a filter coefficient of the filter in the processing period, based on the second signal delayed by the second delayer and the signal difference, and cause the filter to perform the filtering processing in the processing period,
determine a convergence state of the signal difference, and
change the delay amount of the first delayer, a delay amount of the second delayer, or both when the signal difference has not converged.

27. The signal synchronization circuit according to claim 26, wherein the controller is configured to maintain the delay amount of the first delayer, the delay amount of the second delayer, and the filter coefficient in a period other than the processing period.

28. The signal synchronization circuit according to claim 26, wherein
the filter coefficient includes multiple coefficients respectively corresponding to multiple orders of the filter, and
the controller is configured to adjust the delay amount of the second delayer, based on the filter coefficient when the signal difference has converged.

29. The signal synchronization circuit according to claim 28, wherein, when the signal difference has converged, the controller is configured to adjust the delay amount of the second delayer to cause a peak position of the filter coefficient to be positioned within a predetermined range.

30. The signal synchronization circuit according to claim 28, wherein the controller is configured to adjust the delay amount of the second delayer, based on two or more coefficients near a first end and two or more coefficients near a second end among the multiple coefficients included in the filter coefficient.

31. The signal synchronization circuit according to claim 26, further comprising
a third delayer configured to delay the second signal delayed by the second delayer, wherein
the filter coefficient includes multiple coefficients respectively corresponding to multiple orders of the filter, and
the controller is configured to
cause the filter to operate and supply the first signal delayed by the first delayer and the third signal to a post-stage circuit before the signal difference converges,
set a delay amount of the third delayer to a delay amount corresponding to the filter coefficient when the signal difference has converged, and
restrict the operation of the filter and supply the first signal delayed by the first delayer and the second signal delayed by the third delayer to the post-stage circuit after the signal difference converges.

32. The signal synchronization circuit according to claim 26, wherein the controller is configured to
cause the filter to operate before the signal difference converges, and
cause the filter to continuously operate after the signal difference converges.

33. The signal synchronization circuit according to claim 26, further comprising
a third delayer configured to delay the second signal delayed by the second delayer, wherein
the filter coefficient includes multiple coefficients respectively corresponding to multiple orders of the filter,
the controller is operable in a selected operation mode out of a first operation mode and a second operation mode,
in the first operation mode, the controller is configured to
cause the filter to operate before the signal difference converges,
set a delay amount of the third delayer to a delay amount corresponding to the filter coefficient when the signal difference has converged, and
restrict the operation of the filter after the signal difference converges, and
in the second operation mode, the controller is configured to
cause the filter to operate before the signal difference converges, and
cause the filter to continuously operate after the signal difference converges.

34. The signal synchronization circuit according to claim 32, wherein the filter is configured to selectively perform first filtering processing in which both a phase and an amplitude are adjusted and second filtering processing in which the phase is adjusted.

35. The signal synchronization circuit according to claim 34, wherein the controller is configured to cause the filter to perform the first filtering processing both before and after the signal difference converges.

36. The signal synchronization circuit according to claim 34, wherein,
before the signal difference converges, the controller is configured to cause the filter to perform the first filtering processing, acquire the signal difference corresponding to a processing result of the first filtering processing, and supply the third signal to a post-stage circuit, and,
after the signal difference converges, the controller is configured to cause the filter to perform the first filtering processing and acquire the signal difference corresponding to the processing result of the first filtering processing, and thereafter, cause the filter to perform the second filtering processing and supply the third signal obtained through the second filtering processing to the post-stage circuit.

37. The signal synchronization circuit according to claim 34, wherein
the controller is configured to perform selected processing out of first processing and second processing,
in the first processing, both before and after the signal difference converges, the controller is configured to cause the filter to perform the first filtering processing, acquire the signal difference corresponding to a processing result of the first filtering processing, and supply the third signal obtained through the first filtering processing to a post-stage circuit, and
in the second processing,
before the signal difference converges, the controller is configured to cause the filter to perform the first filtering processing, acquire the signal difference corresponding to the processing result of the first filtering processing, and supply the third signal obtained through the first filtering processing to the post-stage circuit, and
after the signal difference converges, the controller is configured to cause the filter to perform the first filtering processing and acquire the signal difference corresponding to the processing result of the first filtering processing, and thereafter, cause the filter to perform the second filtering processing and supply the third signal obtained through the second filtering processing to the post-stage circuit.

38. The signal synchronization circuit according to claim 26, wherein
the filter coefficient includes multiple coefficients respectively corresponding to multiple orders of the filter, and
after the signal difference converges, the controller is configured to monitor whether a peak position of the filter coefficient is positioned within a predetermined range and adjust the delay amount of the second delayer to cause the peak position to be positioned within the predetermined range.

39. The signal synchronization circuit according to claim 22, wherein the controller is configured to detect a synchronization state in the signal synchronization circuit, and, when a synchronization error has occurred, set a delay amount of the first delayer and a delay amount of the second delayer to initial values and control the operations of the first delayer, the second delayer, and the filter to cause the signal difference to become small.

40. A signal processing device comprising:
a signal synchronization circuit configured to generate two signals by performing signal synchronization processing, based on a first signal supplied from a first microphone and a second signal supplied from a second microphone, the two signals corresponding to the first signal and the second signal and being synchronized with each other; and
a processing circuit configured to perform signal processing, based on the two signals, wherein
the signal synchronization circuit includes
a detector configured to detect a sound source, based on the second signal,
a setter configured to set a processing period, based on a result of detecting by the detector,
a first delayer configured to delay the first signal,
a second delayer configured to delay the second signal,
a filter configured to generate a third signal by performing filtering processing, based on the second signal delayed by the second delayer, and
a controller configured to control operations of the first delayer, the second delayer, and the filter in the processing period to cause a signal difference between the first signal delayed by the first delayer and the third signal to become small.

41. A signal synchronization method comprising:
detecting a sound source, based on a second signal out of a first signal supplied from a first microphone and the second signal supplied from a second microphone;
setting a processing period, based on a result of detecting the sound source;
delaying the first signal with a first delayer;
delaying the second signal with a second delayer;
generating a third signal by performing filtering processing with a filter, based on the second signal delayed by the second delayer; and
controlling operations of the first delayer, the second delayer, and the filter in the processing period to cause a signal difference between the first signal delayed by the first delayer and the third signal to become small.

42. A non-transitory computer readable recording medium containing software, the software being configured to cause a processor to
detect a sound source, based on a second signal out of a first signal supplied from a first microphone and the second signal supplied from a second microphone,
set a processing period, based on a result of detecting the sound source,
delay the first signal with a first delayer,
delay the second signal with a second delayer,
generate a third signal by performing filtering processing with a filter, based on the second signal delayed by the second delayer, and
control operations of the first delayer, the second delayer, and the filter in the processing period to cause a signal difference between the first signal delayed by the first delayer and the third signal to become small.
